(19) United States
(12) Patent Application Publication
(10) Pub. No.: US 2015/0362995 A1
(43) Pub. Date: Dec. 17, 2015

(54) TACTILE FORCE PRESENTATION DEVICE, INFORMATION TERMINAL, TACTILE FORCE PRESENTATION METHOD, AND COMPUTER-READABLE RECORDING MEDIUM

(71) Applicant: NEC CORPORATION, Tokyo (JP)

(72) Inventor: Shin NORIEDA, Tokyo (JP)

(21) Appl. No.: 14/763,714

(22) PCT Filed: Jan. 17, 2014
(86) PCT No.: PCT/JP2014/050742

§ 371 Date: Jul. 27, 2015

(30) Foreign Application Priority Data
Jan. 29, 2013 (JP) 2013-014206

(51) Int. Cl. G06F 3/01; G08B 6/00

(52) U.S. Cl. CPC G06F 3/016; G08B 6/00

(57) ABSTRACT

Provided are a tactile force presentation device, an information terminal, a tactile force presentation method, and a program that make it possible to present three-dimensional tactile force across a wide range while achieving a reduction in device size. The information terminal is provided with: a display device; a position detection unit that detects the position of a part of a user that is to be presented with tactile force; an information processing unit that alters content in accordance with a detected position and calculates the amount of tactile force to be presented on the basis of the altered content; and a tactile force presentation device. The tactile force presentation device is provided with: a transmission member that extends to the part of the user that is to be presented with tactile force and transmits tensile force; a drive unit that generates tensile force and provides the tensile force to the transmission member; and a control unit that causes tensile force to be generated as initial force in the drive unit in advance and increases or decreases the initial force when the calculated tactile force is presented so that the tactile force is provided to the user via the transmission member.

### TECHNICAL FIELD

The present invention relates to a tactile force presentation device which presents (transmits) tactile force to a user, an information terminal which includes this tactile force presentation device, such as a POS terminal and a portable terminal (including smartphone and tablet-type device), a tactile force presenting method, and a computer readable storage medium which records a program for realizing these device, terminal and method.

### BACKGROUND ART

According to a conventional input device which receives input operation through a screen, such as a touch panel, feedback for input operation is given to a user only through information presentation constituted by display or sound. This type of input device does not give the user click-like feedback similar to a feeling of pressing an actual key in response to input operation by the user through a software keyboard shown on a display, even at the time of a forceful press on the keyboard. In this case, what is currently in touch with the finger of the user is not recognizable to the user. Accordingly, the user is difficult to receive information on content from the input device, in which condition a problem of low user-friendliness occurs.

For overcoming this problem, for example, PTL 1 discloses a tactile force presentation device which includes a mechanism for moving a display panel to which a touch panel is attached, such that the display panel is movable in a direction corresponding to the thickness of the display panel. This mechanism of the tactile force presentation device disclosed in PTL 1 allows active presentation of tactile force to the user by moving the display panel in accordance with a touch by the finger of the user.

PTL 2 discloses a glove-type force presentation device. The force presentation device disclosed in PTL 2 includes frames along respective fingers of a glove. Each of the frames includes a link in correspondence with a joint of the finger. Each of the links includes a motor for driving the corresponding frame. The tactile force presentation device disclosed in PTL 2 thus constructed is capable of presenting tactile force to the hand of the user wearing the glove via the frames by operating the motors in accordance with contents.

PTL 3 discloses a tactile force presentation device which presents tactile force by using a member (hereinafter referred to as “grip”) 202 held within a space 200 via four wires 201 as illustrated in FIG. 20. FIG. 20 is a view illustrating a general configuration of the tactile force presentation device disclosed in PTL 3.

As illustrated in FIG. 20, the tactile force presentation device disclosed in PTL 3 is disposed within the space 200 in such a condition that two of the four wires 201 pull the grip 202 from diagonal positions in the upper part of the space, while the other two of the four wires 201 pull the grip 202 from diagonal positions in the lower part of the space.

While not shown in FIG. 20, a winding motor is provided for each of the wires 201. Accordingly, the tactile force presentation device disclosed in PTL 3 is capable of adjusting tensile forces τ₁ through τ₄ of the respective wires 201 by operating the respective motors in accordance with the contents so as to present tactile force to the user via the grip 202 held by the respective wires 201.

### CITATION LIST

### Patent Literature

PTL 1: Japanese Patent Publication No. 4039344
PTL 2: Japanese Laid-open Patent Publication No. 2003-308141
PTL 3: Japanese Laid-open Patent Publication No. 2003-172662

### SUMMARY OF INVENTION

### Technical Problem

As described above, each of the tactile force presentation devices disclosed in PTL 1 through PTL 3 is capable of presenting tactile force to the user, unlike the conventional input devices such as a touch panel. However, there still exist the following problems.

Initially, the tactile force presentation device disclosed in PTL 1 has a complicated structure for operating the entire touch panel, and therefore is large-sized and heavy. Accordingly, this device is difficult to be mounted on a portable-type information terminal such as a smartphone. In addition, the tactile force presentation device disclosed in PTL 1 is only allowed to present tactile force within a narrow range in the thickness direction of the screen, and therefore is also difficult to present three-dimensional tactile force in a wide range.

On the other hand, the tactile force presentation device disclosed in PTL 2 is capable of presenting three-dimensional tactile force in a wide range. However, this device requires a complicated link mechanism, and therefore becomes large-sized and heavy. Accordingly, the device in PTL 2 is also difficult to be mounted on a portable-type information terminal. In addition, the inertia force of the frames affects the force presentation due to the structural characteristics of the device, and therefore, presenting accurate tactile force may be difficult.

The tactile force presentation device disclosed in PTL 3 is capable of presenting three-dimensional tactile force in a wide range. However, for allowing such presentation, the motors provided to pull the wires 201 are required to be disposed at pull start positions of the wires 201 within the space 200 (see FIG. 20). Accordingly, this device is also difficult to be mounted on a portable-type information terminal.

For solving the aforementioned problems, it is an example of objects of the present invention to provide a tactile force presentation device, an information terminal, a tactile force presenting method, and a computer readable storage medium, as a technology capable of presenting three-dimensional tactile force in a wide range while reducing a device size.

### Solution to Problem

For achieving the above-mentioned objet, a tactile force presentation device according to an aspect of the present invention presents tactile force to a user in accordance with contents displayed on a screen. The device is characterized by including:

a transmitting member that extends toward a portion at which the user receives presentation of the tactile force from the device, and transmits a force to the user as the force in a pulling direction;

a driving unit that generates the force in the pulling direction, and gives the force to the transmitting member; and

a control unit that allows the driving unit to generate the force in strength set beforehand in the pulling direction as an initial force, and increases or decreases the initial force such that the tactile force for presentation is transmitted to the user via the transmitting member in the presentation of the tactile force.

For achieving the above-mentioned object, an information terminal according to an aspect of the present invention is capable of presenting tactile force to a user in accordance with contents displayed on a screen. The terminal is characterized by including:

a display device that displays the content on the screen;

a position detecting unit that detects a position of a portion at which the user receives presentation of the tactile force;

an information processing unit that changes contents of the content in accordance with a detected position, and calculates tactile force for presentation based on the changed contents of the content; and

a tactile force presentation device, wherein

the tactile force presentation device includes
a transmitting member that extends from the information terminal toward the portion at which the user receives presentation of the tactile force, and transmits a force to the user as the force in a pulling direction,
a driving unit that generates the force in the pulling direction, and gives the force to the transmitting member, and
a control unit that allows the driving unit to generate the force in strength set beforehand in the pulling direction as an initial force, and increases or decreases the initial force such that the calculated tactile force is transmitted to the user via the transmitting member in the presentation of the tactile force calculated by the information processing unit.

For achieving the above-mentioned object, a tactile force presenting method according to an aspect of the present invention presents tactile force to a user in accordance with contents displayed on a screen. The method uses a device that includes a transmitting member that extends toward a portion at which the user receives presentation of the tactile force, and transmits a force to the user as the force in a pulling direction, and a driving unit that generates the force in the pulling direction, and gives the force to the transmitting member. The method is characterized by including:

(a) a step for allowing the driving unit to generate the force in strength set beforehand in the pulling direction as an initial force; and

(b) a step for increasing or decreasing the initial force such that the tactile force for presentation is transmitted to the user via the transmitting member in the presentation of the tactile force.

For achieving the above-mentioned object, a computer readable storage medium according to an aspect of the present invention is characterized by storing a program that causes a device which includes a transmitting member that extends toward a portion of a user for receiving presentation of the tactile force, and transmits the force to the user as the force in a pulling direction, a driving unit that generates the force in the pulling direction, and gives the force to the transmitting member, and a computer to execute:

(a) a step for allowing the driving unit to generate the force in strength set beforehand in the pulling direction as an initial force; and

(b) a step for increasing or decreasing the initial force such that the tactile force for presentation is transmitted to the user via the transmitting member in the presentation of the tactile force

so that the device presents the tactile force to the user in accordance with contents displayed on a screen.

### Advantageous Effects of Invention

According to the present invention, as noted above, presentation of three-dimensional tactile force is achievable in a wide range together with reduction of a device size.

### BRIEF DESCRIPTION OF DRAWINGS

FIG. 1 is a perspective view illustrating an external appearance of an information terminal according to a first exemplary embodiment of the present invention.

FIG. 2 is an exploded perspective view illustrating respective constituent parts of the information terminal according to the first exemplary embodiment of the present invention.

FIG. 3 is a block diagram illustrating a configuration of the information terminal according to the first exemplary embodiment of the present invention.

FIG. 4 is a flowchart showing operation of an information terminal 100 according to the first exemplary embodiment of the present invention.

FIG. 5 is a view illustrating step S101 shown in FIG. 4

FIG. 6 is a view illustrating step S103 shown in FIG. 4.

FIG. 7(a) is a view illustrating a tensile force calculation process, while FIG. 7(b) is a view illustrating coordinate axes used for the tensile force calculation process.

FIG. 8 is a view illustrating a presentation force reset process.

FIG. 9 is a view illustrating an example of a head-mounted display including the tactile force presentation device according to the first exemplary embodiment of the present invention.

FIG. 10 is a perspective view illustrating another example of the information terminal according to the first exemplary embodiment of the present invention.

FIG. 11 is a view illustrating another example of an attachment member employed in the first exemplary embodiment of the present invention.

FIG. 12 is a view illustrating an example of content to which the first exemplary embodiment is applicable.

FIG. 13 illustrates a situation that content displayed on a screen of the information terminal is an experimental model for describing a principle of leverage.

FIG. 14 illustrates a situation that content displayed on the screen of the information terminal is a model for describing a mechanism of a typhoon.

FIG. 15 is a perspective view illustrating an external appearance of an information terminal according to a second exemplary embodiment of the present invention.

FIG. 16 is a view illustrating a use example of the information terminal according to the second exemplary embodiment of the present invention.

FIG. 17 is a block diagram illustrating a configuration of the information terminal according to the second exemplary embodiment of the present invention.

FIG. 18(a) is a view illustrating an example of a screen displayed on an information terminal according to a modified example of the second exemplary embodiment of the present invention, while FIG. 18(b) is a view illustrating a relationship between the screen and the direction of the face of a user.

FIG. 19(a) is a view illustrating an example of a screen displayed on the information terminal according to the modified example of the second exemplary embodiment of the present invention, while FIG. 19(b) is a view illustrating a relationship between the screen and the direction of the face of the user.

FIG. 20 is a view illustrating a general configuration of a tactile force presentation device disclosed in PTL 3.

### DESCRIPTION OF EMBODIMENTS

### First Exemplary Embodiment

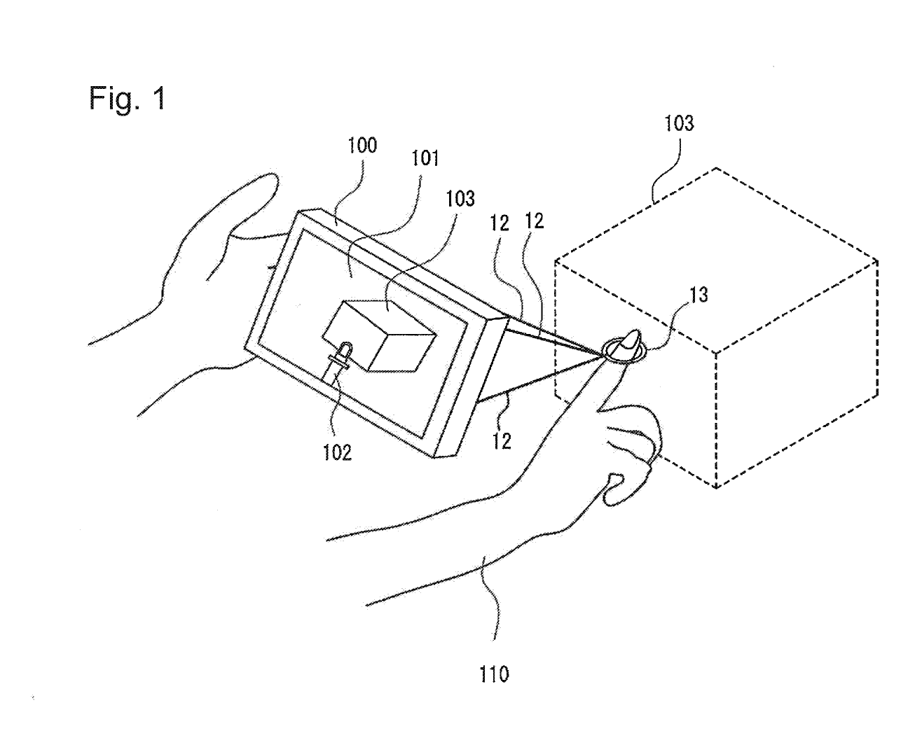

A tactile force presentation device, an information terminal, a tactile force presenting method, and a program according to a first exemplary embodiment of the present invention are hereinafter described with reference to FIGS. 1 through 14.

[Device Configuration]

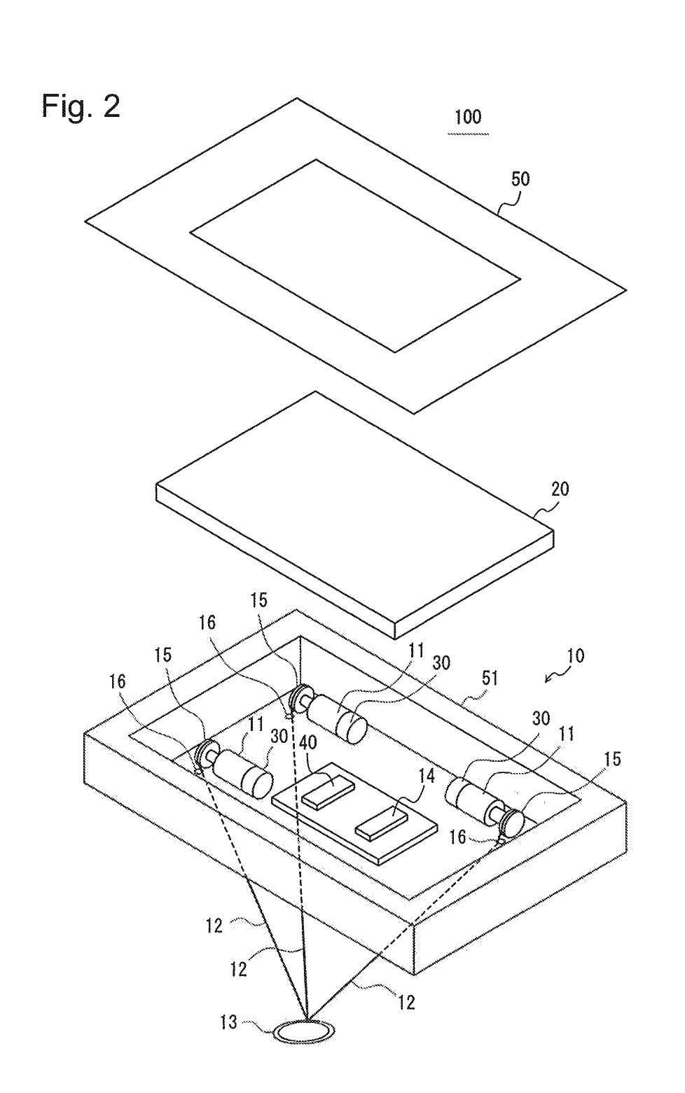

Initially, respective configurations of the tactile force presentation device and the information terminal according to the first exemplary embodiment are described with reference to FIGS. 1 and 2. FIG. 1 is a perspective view illustrating an external appearance of the information terminal according to the first exemplary embodiment of the present invention. FIG. 2 is an exploded perspective view illustrating respective constituent parts of the information terminal according to the first exemplary embodiment of the present invention.

The external appearance configuration of the information terminal according to the first exemplary embodiment is now discussed with reference to FIG. 1. As illustrated in FIG. 1, an information terminal 100 according to the first exemplary embodiment is a tablet-type information terminal, and includes a tactile force presentation device which presents tactile force to a user 110, as illustrated in FIG. 2 to be referred to later.

According to the first exemplary embodiment, the information terminal 100 is capable of detecting a portion at which the user 110 receives presentation of tactile force, i.e., a position of a finger, in a space on the terminal rear side (on the side opposite to the side where a screen 101 is disposed). Accordingly, the user 110 is capable of inputting operation by shifting the position of the finger.

The information terminal 100 is also capable of displaying a virtual space on the screen 101, and also capable of displaying an object 102 (hereinafter referred to as “user object”) indicating the finger of the user 110 within the virtual space in correspondence with the detected position of the finger. When the user object 102 contacts to a virtual object 103 disposed within the virtual space, the tactile force presentation device of the information terminal 100 transmits a sense of touch on the virtual object 103 to the finger of the user 110.

In other words, the information terminal 100 presents an action and a state to the user 110 as tactile force within the vertical space in response to a shift of the finger of the user 110 or movement of the virtual object 103. In FIG. 1, the virtual object 103 when placed in an actual space is indicated by broken lines to clarify a positional relationship between the finger of the user 110 and the virtual object 103.

An internal configuration of the information terminal is now described with reference to FIG. 2. As illustrated in FIG. 2, the information terminal 100 includes a display device 20 which displays content on the screen, position detecting units 30, an information processing unit 40, and a tactile force presentation device 10 which presents tactile force to the user 110 (see FIG. 1).

Each of the position detecting units 30 detects a position of a portion (finger in the example in FIG. 1 and FIG. 2) of the user 110 for receiving presentation of tactile force. The information processing unit 40 varies contents of the content in correspondence with the detected position, and calculates tactile force for presentation based on the varied contents of the content.

As illustrated in FIG. 2, the tactile force presentation device 10 includes transmitting members 12, driving units 11, and a control unit 14. Each of the transmitting members 12 extends from the information terminal 100 toward the portion (finger in the example in FIG. 1 and FIG. 2) of the user 110 for receiving presentation of tactile force, and transmits force to the user 110 as force in a pulling direction (hereinafter referred to as “tensile force”). Each of the driving units 11 generates tensile force and gives the force to the corresponding transmitting member 12.

The control unit 14 initially allows each of the driving units 11 to generate tensile force in strength set beforehand as initial force. Then, the control unit 14 increases or decreases the initial force such that each of the driving units 11 can give calculated tactile force to the user 110 (see FIG. 2) via the corresponding transmitting member 12 in the presentation of the tactile force calculated by the information processing unit 40.

As discussed above, in the information terminal 100, the tactile force presentation device 10 presents tactile force to the finger of the user 110 positioned on the rear side of the information terminal 100 by transmitting the pulling-direction force to the finger via the transmitting members 11. Accordingly, presentation of three-dimensional tactile force is achievable in a wide range. Moreover, miniaturization is allowed for the configuration of the tactile force presentation device 10, wherefore size reduction of the device is also achievable. The “tactile force” in the context of the present invention refers to repulsion force, resistance force, external force, a sense of touch, and others felt by the user.

More specific configurations of the information terminal 100 and the tactile force presentation device 10 according to the first exemplary embodiment are now described.

As illustrated in FIG. 2, the information terminal 100 includes a frame-shaped cover 50, the display device 20, and a box-shaped housing 51 disposed in this order from the user side. The cover 50 is attached to an opening portion of the housing 51 in such a condition that a screen of the display device 20 is exposed through the cover 50. The display device 20 is constituted by a thin display panel, such as a liquid crystal display panel and an organic EL panel.

The driving units 11, the control unit 14, the position detecting units 30, and the information processing unit 40 noted above are disposed inside the housing 51 on the rear side of the display device 20. As illustrated in FIG. 2, the three transmitting members 12 are provided in the first exemplary embodiment, and the three driving units 11 are disposed in correspondence with the transmitting members 12.

According to the first exemplary embodiment, each of the transmitting members 12 is constituted by a string-shaped member, such as a wire, and configured such that the respective transmitting members 12 extend from different positions on the rear side of the information terminal 100 toward the portion (finger) of the user 110 for receiving presentation of tactile force. Each tip of the transmitting members 12 is fixed to an attachment member 13 attached to the portion of the user 110 for receiving presentation of tactile force. More specifically, the attachment member 13 is a ring-shaped member attachable to the finger of the user 110.

According to the first exemplary embodiment, each of the driving units 11 is constituted by a motor which includes a pulley 15 attached to a shaft of the motor. Each of the driving units 11 gives force in the pulling direction to the corresponding transmitting member 12 by winding the corresponding transmitting member 12 around the pulley 15.

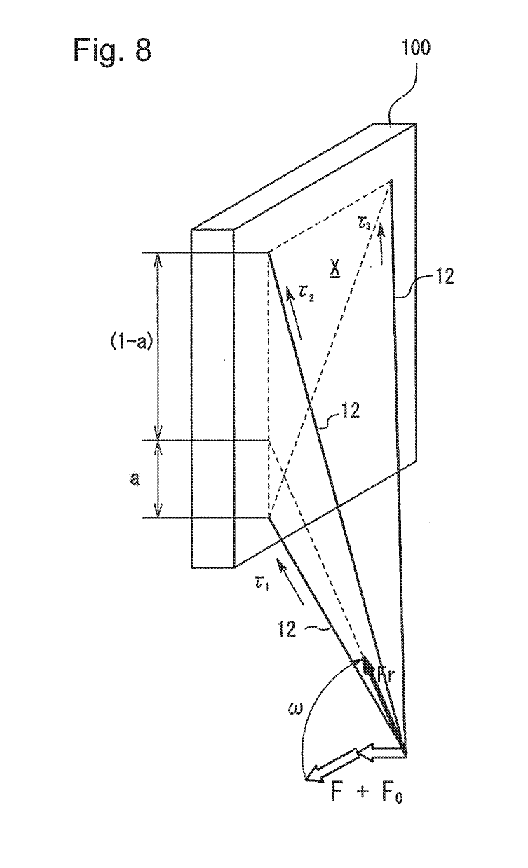

A through hole 16 is formed in the bottom of the housing 51 in correspondence with each of the transmitting members 12. Each of the transmitting members 12 passes through the corresponding through hole 16 and extends toward the rear side of the information terminal 100. While the positions of the respective through holes 16 are not particularly limited, a presentation range of tactile force is determined by the positions of the respective through holes 16 (see a range X in FIG. 8) as will be detailed later. Accordingly, the positions of the respective through holes 16 are determined in consideration of the desired presentation range.

According to the first exemplary embodiment, therefore, presentation force is presented to the finger of the user 110 based on pulling of the attachment member 13 from the three transmitting members 12 (see FIG. 1). In other words, tactile force is presented as the resultant force of the tensile forces given from the respective driving units 11 to the transmitting members 13.

According to the first exemplary embodiment, each of the position detecting units 30 is constituted by an encoder provided on the shaft of the corresponding driving unit 11. Accordingly, each of the position detecting units 30 outputs data for specifying the number of revolutions of the shaft of the corresponding motor to the information processing unit 40 as data (hereinafter referred to as “position detection data”) for detecting the position of the portion of the user for receiving presentation of tactile force.

The information processing unit 40 having received the position detection data output from the respective position detecting units 30 calculates lengths between the through holes 16 of the respective transmitting members 12 and the attachment member 13 based on the entire lengths of the transmitting members 12, the diameters of the pulleys 15, the distances between the pulleys 15 and the through holes 16, all values of which have been registered beforehand, As will be detailed later, the information processing unit 40 calculates the position of the portion of the user 110 for receiving presentation of tactile force, i.e., the position of the attachment member 13, based on the calculated lengths of the respective transmitting members 12.

According to the first exemplary embodiment, each of the control unit 14 and the information processing unit 40 is realized by a computer such as a microcomputer. The respective units 14 and 40 may be constituted by separate computers, or realized by the same computer.

According to the first exemplary embodiment, each of the string-shaped members (transmitting members 12) is provided as a mechanism for transmitting force generated by the motor which functions as the driving unit 11, as illustrated in FIG. 2. In this case, weight reduction of the constituent parts of the tactile force presentation device 10, and simplification of the mechanism for presenting tactile force are both achievable, wherefore the size and weight of the information terminal 100 can decrease.

According to the first exemplary embodiment, the transmitting direction of the tensile force generated by each of the driving members 12 is allowed to be arbitrarily determined by adjusting the positions of the pulley 15 and the through hole 16. In addition, the distance between the through hole of each of the transmitting members 12 and the attachment member 13 is allowed to be arbitrarily determined in accordance with the winding amount of the pulley 15. In this case, a wide range may be established for a shift of the finger of the user, wherefore presentation of three-dimensional tactile force is achievable in a wide range. In addition, each of the transmitting members 12 is constituted by a lightweight string-shaped component, in which condition mechanical resistance or the like felt by the user when the user moves the finger may decrease.

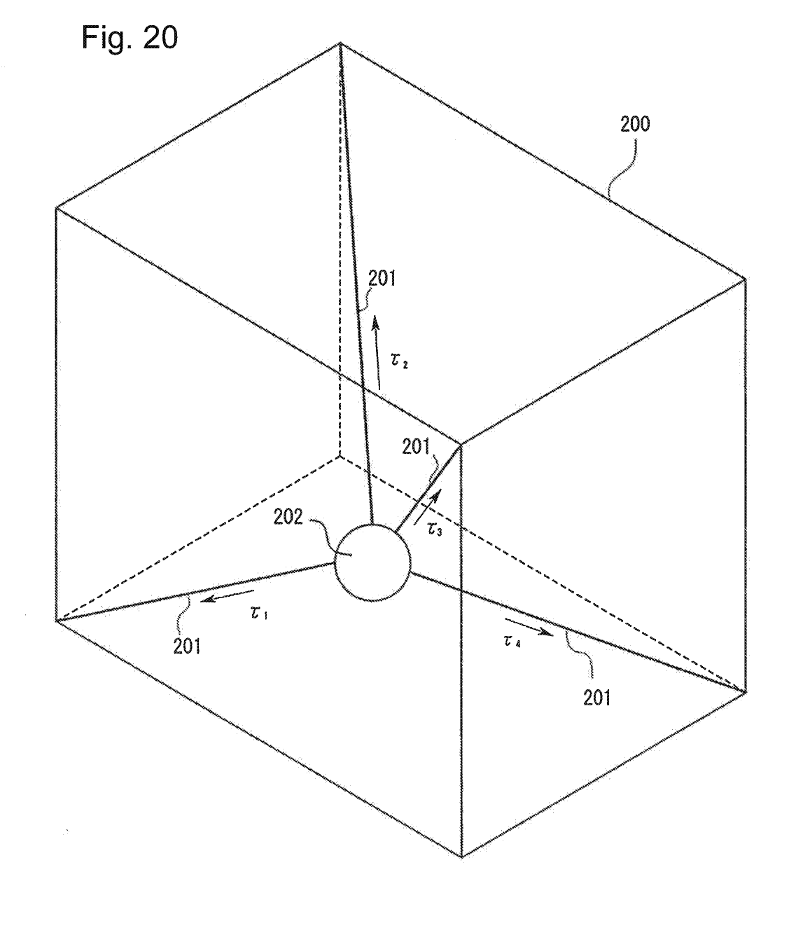

According to the tactile force presentation device disclosed in PTL 3 discussed with reference to FIG. 20, the motors for pulling the wires are required to be disposed in the upper part and the lower part within the space. However, according to the first exemplary embodiment, the driving units 11 are disposed in a flat plane on the bottom of the housing 51, as illustrated in FIG. 2. Accordingly, the tactile force presentation device 10 illustrated in FIG. 2 is easily mounted on the information terminal 100 having a flat shape.

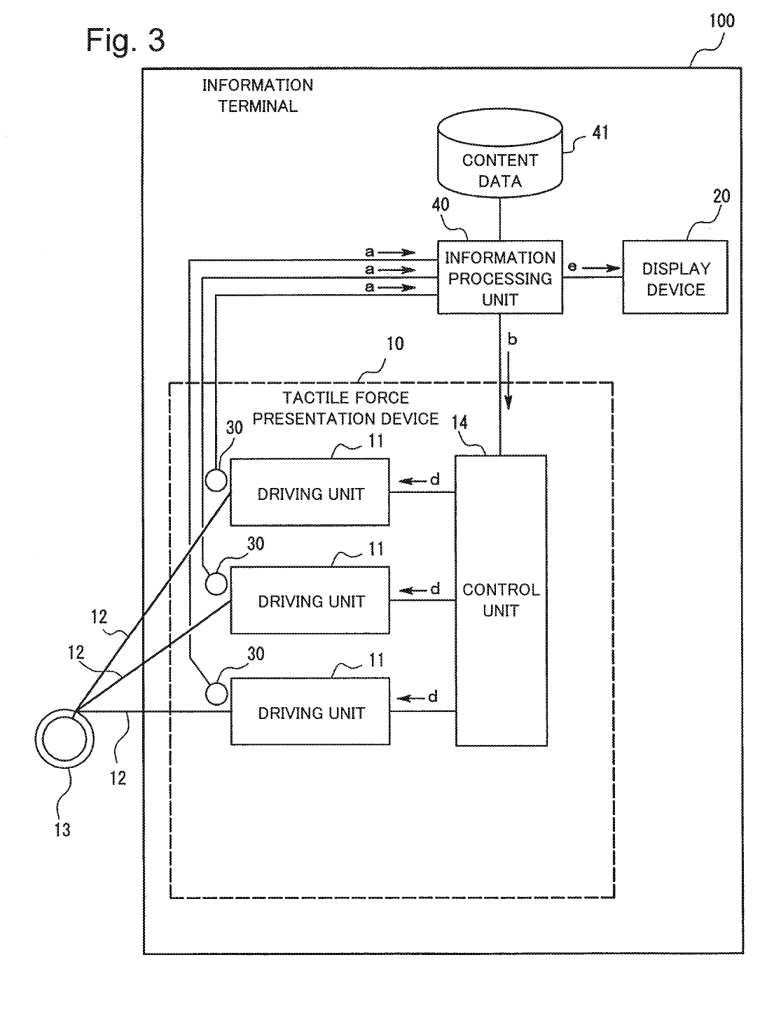

Data exchanged within the information terminal 100 is now described with reference to FIG. 3. FIG. 3 is a block diagram illustrating a configuration of the information terminal according to the first exemplary embodiment of the present invention.

As illustrated in FIG. 3, the information processing unit 40 is connected with the display device 20, the position detecting units 30, and the control unit 14. The control unit 14 is connected with the driving units (motors) 11.

According to this configuration, each of the position detecting units 30 outputs position detection data a to the information processing unit 40 when the user 110 shifts the finger on the rear side of the information terminal 100 in the state in which the attachment member 13 is attached to the finger. The information processing unit 40 having received the respective position detection data a specifies the position of the finger of the user 110 (attachment member 13) based on the respective data a.

The information processing unit 40 having specified the position of the finger of the user 110 changes the position of the user object 102 (see FIG. 1) in accordance with the specified position. Then, the information processing unit 40 performs a process for linking the user object 102 with the virtual object 103 contained in the content while referring to content data 41, and outputs display information on the content reflecting the processed contents to the display device 20 as display data e.

Specific examples of the content data 41 include data on an application program providing a virtual space, such as a game program and a simulation program, and further include data on websites. The content data 41 may be stored in a storage device included in the information terminal 100, or may be stored in a separated device (computer) connected via the Internet.

The information processing unit 40 in this step calculates force generated in the user object 102 within the virtual space, and outputs data b (hereinafter referred to as “presentation data b”) for specifying the calculated force to the control unit 14. The calculated force is repulsion force or the like generated in the object, and corresponds to tactile force to be transmitted to the user.

The control unit 14 having received the presentation data b calculates tensile forces to be output from the respective driving units 11 such that tactile force specified by the presentation data b can be transmitted to the user 110. Then, the control unit 14 creates control data d for generating desired tensile forces from the respective driving units 11, and outputs the control data d to the respective driving units 11.

More specifically, the control unit 14 generates a pulse signal by using a power circuit (not shown) as a signal for driving the motors functioning as the driving units 11, and outputs this pulse signal as the control data d. In response to this signal, the respective driving units (motors) 11 pull the transmitting members 12 by the calculated tensile forces to present tactile force specified by the presentation data b to the finger tip of the user 110.

[Device Operation]

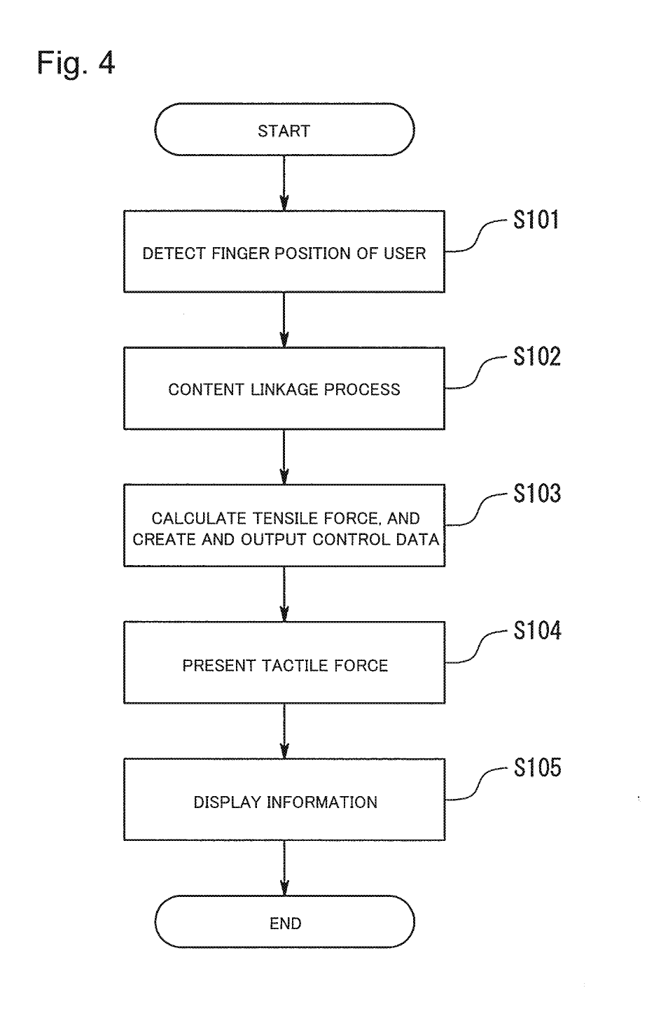

Operations of the information terminal 100 and the tactile force presentation device 10 according to the first exemplar embodiment of the present invention are hereinafter described with reference to FIG. 4. FIG. 4 is a flowchart showing the operation of the information terminal 100 according to the first exemplary embodiment of the present invention. The following description will be given with reference to FIGS. 1 through 3 as necessary. The tactile force presenting method according to the first exemplary embodiment is executed by operation of the tactile force presentation device 10. Accordingly, the following description concerning the operation of the tactile force presentation device 10 is applicable to the description of the tactile force presenting method according to the first exemplary embodiment.

It is initially assumed that the user 110 shifts the finger in the space on the rear side of the information terminal 100 to operate content displayed on the screen of the display device 20. In response to the shift of the finger, each of the position detecting units 30 outputs the position detection data a to the information processing unit 40 as illustrated in FIG. 3.

As illustrated in FIG. 4, the information processing unit 40 calculates each length of the transmitting members 12 between the through hole 16 and the attachment member 13 based on the obtained position detection data a. In addition, the information processing unit 40 specifies the position of the finger of the user 110 based on the lengths of the respective transmitting members 12 thus calculated (S101). Furthermore, the information processing unit 40 varies the position of the user object 102 (see FIG. 1) in accordance with the specified position.

The information processing unit 40 executes the process for linking the virtual object 103 with the user object 102 (content linkage process) while referring to the content data 41 (step S102). In step S102, the information processing unit 40 outputs the display information on the content reflecting the process contents of the content linkage process to the display device 20 as display data e. In step S102, the information processing unit 40 further calculates force generated in the user object 102 within the virtual space, and outputs the presentation data b for specifying the calculated force to the control unit 14.

The control unit 14 having received the presentation data b from the information processing unit 40 calculates tensile forces to be output from the respective driving units 11 for presentation of presentation force specified by the presentation data b (step S103). In step S103, the control unit 14 further creates the control data d for generating the calculated tensile forces from the respective driving units 11, and outputs the control data d to the respective driving units 11.

After execution of step S103, the tactile force presenting device 10 presents tactile force to the finger tip of the user 110 via the attachment member 13 (step S104). In addition, the content after the content linkage process is displayed on the screen 101 of the display device based on the presentation data e output from the information processing unit 40 in step S102 (step S105). Processes in step S104 and step S105 may be simultaneously executed.

According to the first exemplary embodiment, the processes from step S101 to step S105 are repeatedly executed. When the user 110 shifts the finger from a certain position to a different position, the processes in step S101 through S105 are repeated during the period from the start to the end of this shift. Accordingly, the user 110 is allowed to continuously receive presentation of tactile force during this period.

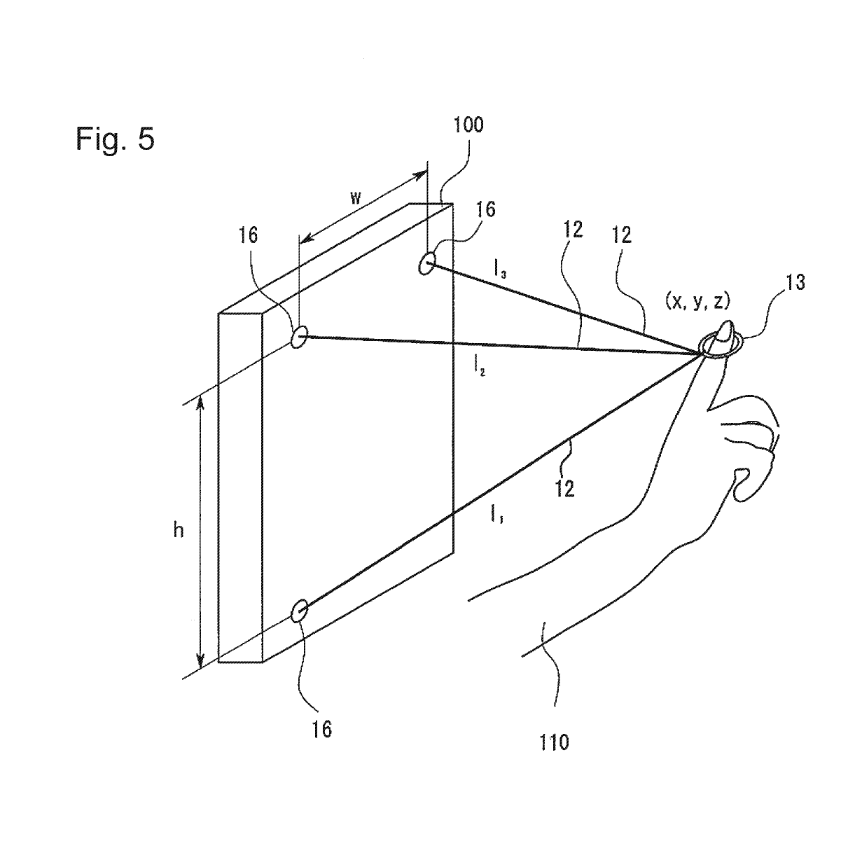

The respective steps from step S101 to step S105 shown in FIG. 4 are further detailed hereinbelow with reference to FIGS. 5 through 8.

[Step S101]

Initially, step S101 (finger position detection process) shown in FIG. 4 is described with reference to FIG. 5. FIG. 5 is a view illustrating step S101 shown in FIG. 4. In the finger position detection process in step S101, the position of the attachment member 13 to which the tips of the transmitting members 12 are connected is specified on the rear side of the information terminal 100 based on the lengths of the transmitting members 12 as noted above. The lengths of the transmitting members 12 are specified by the position detecting units 30.

More specifically, as illustrated in FIG. 5, the lengths of the respective transmitting members 12 between the through holes 16 and the attachment member 13 are set to l₁, l₂, and l₃, respectively, the distance between the adjoining through holes in the horizontal direction of the screen is set to w, and the distance between the adjoining through holes in the vertical direction is set to h. In this case, the information processing unit 40 calculates coordinates (x, y, z) of the attachment member 13 in a geometrical manner using the lengths l₁, l₂, and l₃, the distance w, and the distance h.

### [Step S102]

Step S102 (content linkage process) shown in FIG. 4 is now described with reference to FIG. 1. In the content linkage process in step S102, the user object 102 moves within the virtual space in accordance with the actual shift of the finger of the user 110 as noted above. Moreover, the virtual object 103 within the virtual space moves in linkage with the user object 102.

More specifically, the information processing unit 40 moves the virtual object 103 in accordance with the movement of the user object 102 to establish interaction between the virtual object within the virtual space and the object (finger of the user 110) within an actual space. In this case, the information processing unit 40 simulates a positional change and a contact force when the user object 102 and the virtual object 103 contact each other by using a physical simulator in the virtual space.

Then, the information processing unit 40 calculates reaction generated in the user object 102 and the virtual object 103 as a result of the contact therebetween based on physical coefficients of both the objects within the virtual space. Examples of the physical coefficients include mass, speed, acceleration, contact direction, restitution coefficient and others for each of the user object 102 and the virtual object 103.

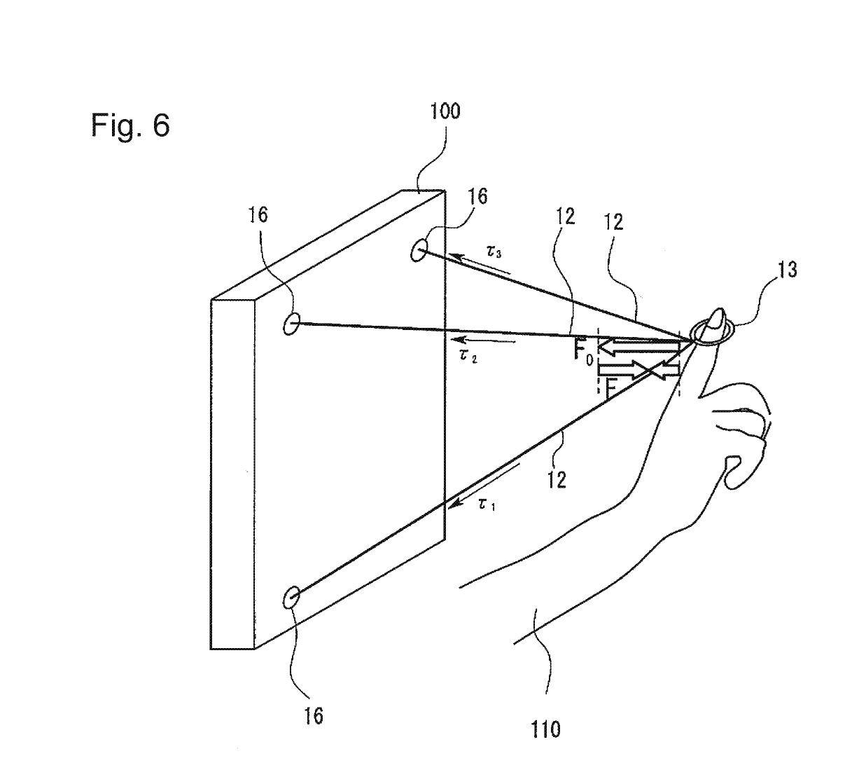

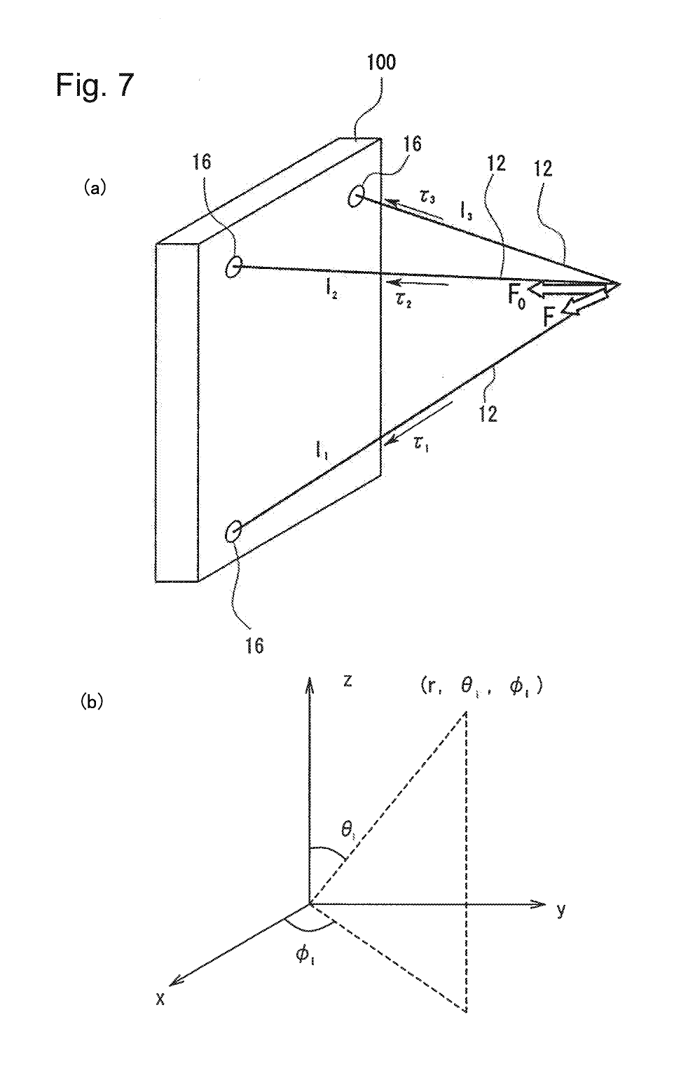

In the respective reaction thus calculated, reaction given to the user object 102 from the virtual object 103 corresponds to tactile force to be presented to the user 110 (see FIGS. 6 and 7 to be referred to later). Accordingly, assuming that the reaction given to the user object 102 from the virtual object 103 is “presentation force F”, the information processing unit 40 outputs the presentation data b for specifying the presentation force F to the control unit 14 to allow presentation of the presentation force F. In addition, the information processing unit 40 outputs data for displaying the user object 102 and the virtual object 103 in this step to the display device 20 as the display data e corresponding to display information.

[Step S103]

Step S103 (tensile force calculation process and control data creation process) shown in FIG. 4 is now described with reference to FIGS. 6 and 7.

FIG. 6 is a view illustrating step S103 shown in FIG. 4. As illustrated in FIG. 6, assuming that tensile forces of the respective transmitting members 12 required for presenting the desired presentation force F are τ₁, τ₂, and τ₃, respectively, the presentation force F basically corresponds to the resultant force of the respective tensile forces τ₁, τ₂, and τ₃.

When the presentation force F is a force in the direction from the outside toward the information terminal 100, the direction of the presentation force F agrees with the direction of the resultant force of the tensile forces τ₁, τ₂, and τ₃. However, when the presentation force F is a force in the direction away from the information terminal 100 as illustrated in FIG. 6, tactile force may be difficult to be presented using the transmitting members 12 which are string-shaped components and capable of transmitting only force in the pulling direction toward the information terminal 100.

According to the first exemplary embodiment, therefore, the control unit 14 constantly presents a certain force to the finger of the user (attachment member 13) as initial force F₀ in advance during the period not presenting tactile force as noted above. When the presentation force F is a force in the direction away from the information terminal 100, the control unit 14 presents tactile force in the direction away from the information terminal 100 by decreasing the initial force F₀.

In general, a human exhibits a phenomenon of tactile sensation called adaptation as time characteristics. Adaptation is such a phenomenon that sensitivity of a human to a stimulus decreases with continuous presentation of a certain stimulus to the human. In other words, the skin of a human is extremely adaptable to pressure, wherefore a human easily loses the consciousness of wearing while wearing a ring or a wrist watch.

This applies to the stimulus of gravity as well. A human is usually unaware of the force of gravity. For example, the resultant force of inertial force and gravity is applied to a human on a moving train at the time of acceleration or deceleration. However, the human on the train does not feel this resultant force, but only feels the inertial force in the moving direction.

Based on this mechanism of human adaptation, presentation for both tactile force in the direction toward the information terminal 100, and tactile force in the direction away from the information terminal 100 is achievable by increasing or decreasing the initial force F₀ according to the first exemplary embodiment.

A specific calculation method of the tensile forces τ₁, τ₂, and τ₃ given to the transmitting members 12 is hereinafter described with reference to FIG. 7. FIG. 7(a) is a view illustrating a tensile force calculation process, while FIG. 7(b) is a view illustrating coordinate axes used for the tensile force calculation process.

In FIGS. 7(a) and 7(b), the tensile force τ₁, τ₂, and τ₃ are tensile forces after subtraction of tensile force required for generating the initial force F₀, and correspond to tensile forces to be added to or subtracted from the initial force F₀. In FIGS. 7(a) and 7(b), the origin of the coordinate axes corresponds to each tip of the transmitting members 12. The x axis is an axis in parallel with the horizontal direction of the screen. The y axis is an axis in parallel with the vertical direction of the screen. The z axis is an axis in parallel with the normal of the screen. In FIG. 7(b), the coordinates of a unit vector r are set to (r, ψᵢ, θᵢ). In this case, the tensile forces τ₁, τ₂, and τ₃ are required to have the following relation of Equation 1 so as to provide a desired presentation force.

$${\sum }_{i = 1}^{3} {τ}_{i} {Φ}_{i} - {F}_{0} = F \qquad [ Equation 1 ]$$

In Equation 1, the tensile forces τ₁, τ₂, and τ₃ of the transmitting members 12 are expressed in scalar quantity, while respective directional vectors φᵢ of the tensile forces τ₁, τ₂, and τ₃, are represented by following Equation 2.

$${Φ}_{1} = ( \begin{matrix}sin {θ}_{i} cos {ϕ}_{i} \\ sin {θ}_{i} sin {ϕ}_{i} \\ cos {θ}_{i}\end{matrix} ) \qquad [ Equation 2 ]$$

The control unit 14 calculates the tensile forces τ₁, τ₂, and τ₃ by using Equation 1 and Equation 2. As shown in Equation 1, the desired presentation force F is obtained by subtracting the initial force F₀ from the tensile forces of the respective transmitting members 12. Accordingly, presentation of tactile force is allowed even in the direction away from the information terminal 100 (−z direction) as long as the presentation force F in the direction away from the information terminal 100 (−z direction) does not exceed the initial force F₀.

The tensile forces τ₁, τ₂, and τ₃ are only allowed to be presented in the pulling direction according to the conditions of the tensile forces of the respective transmitting members 12, and therefore always become positive values. In addition, assuming that the minimum value of each of the tensile forces is τₘᵢₙ, following Equation 3 holds.

0<τₘᵢₙ≦τ₁ [Equation 3]

The transmitting members 12 are only allowed to transmit force in the pulling direction. Accordingly, there may occur such a situation where tactile force for presentation is difficult to be presented based on the resultant force of the tensile forces τ₁, τ₂, and τ₃ (see FIG. 8). More specifically, when the attachment member 13 lies at a position not overlapping with the range in the direction in parallel with the normal of the screen (z axis direction), which range has been defined by the lines connecting the adjoining through holes 16 (see range X in FIG. 8), there is a possibility that the desired presentation force F is difficult to be calculated based on Equation 1. In this case, the control unit 14 according to the first exemplary embodiment resets tactile force for presentation (presentation force F) by increasing or decreasing the initial force F₀ such that reset presentation force Fr can be presented. This reset process is hereinafter specifically described.

FIG. 8 is a view illustrating a presentation force reset process. As illustrated in FIG. 8, it is assumed herein that the position (x, y, z) of the attachment member 13 lies at a position not overlapping with the range X in the z axis direction, as the range defined by the lines connecting the adjoining through holes 16, for example.

In the case illustrated in FIG. 8, it is impossible to calculate the presentation force F based on Equation 1 and Equation 2 at any settings of the tensile forces of the respective transmitting members 12 unless the component of the presentation force F in the x-axis direction is positive. On the other hand, the user is allowed to shift the finger to a position overlapping with the range X in the z axis direction even in this situation. Accordingly, the control unit 14 determines the presentation force Fr as the presentation force so as to allow calculation of the tensile forces τ₁, τ₂, and τ₃ based on Equation 1 and Equation 2 in this situation.

In case of the example illustrated in FIG. 8, an actual desired direction of pulling by the tensile forces τ₁, τ₂, and τ₃ is the direction of the resultant force of the presentation force F and the initial force F₀. However, this is not the pulling direction allowed for the resultant force of the respective transmitting members 12. Accordingly, the control unit 14 calculates a force closest to the resultant force of the presentation force F and the initial force F₀, and determines the calculated force as the new presentation force Fr.

According to the example illustrated in FIG. 8, the presentation force Fr generated by the tensile forces τ₁ and τ₂ is close to the resultant force of the original presentation force F and the initial force F₀. Accordingly, the control unit 14 conducts revolved projection of the resultant force of the original presentation force F and the initial force F₀ on a plane defined by the two transmitting members 12 generating the tensile force τ₁ and the tensile force τ₂ to determine the new presentation force Fr.

More specifically, a projection vector V on the plane defined by the two transmitting members 12 generating the tensile force τ₁ and the tensile force τ₂ is expressed by following Equation 4. As illustrated in FIG. 8, a variable “a” in Equation 4 indicates a position where a revolution angle ω becomes the minimum when the revolved projection is performed, i.e., a position expressed in a ratio (0<a<1) on the side of the range X of the screen in the vertical direction. A value φ₁ is a directional vector of the tensile force τ₁ with respect to the through hole 16. A value φ₂ is a directional vector of the tensile force τ₂ with respect to the through hole 16. The values φ₁ and φ₂ are calculated based on Equation 2 noted above.

V=aτ₁Φ₁+(1−a)τ₂Φ₂ [Equation 4]

Accordingly, the control unit 14 calculates the projection vector which minimizes the inner product of the projection vector V and the resultant force of the original presentation force F and the initial force F₀ based on following Equation 5. Then, the control unit 15 applies the calculated projection vector to following Equation 6 to calculate the new presentation force Fr. Subsequently, the control unit 15 calculates the tensile forces τ₁, τ₂, and τ₃ of the respective transmitting members 12 by using the new presentation force Fr, creates the control data d for generating these tensile forces, and outputs the control data d to the respective driving units 11.

$$\begin{matrix}min \text{:} \{ a {τ}_{1} {Φ}_{1} + ( 1 - a ) {τ}_{2} {Φ}_{2} \} \cdot ( F + {F}_{0} ) & [ Equation 5 ] \\ Fr = \frac{( F + {F}_{0} ) \cdot V}{{\vert V \vert}^{2}} V - {F}_{0} & [ Equation 6 ]\end{matrix}$$

### Modified Examples of First Exemplary Embodiment

### Modified Example 1

According to the foregoing example, the three transmitting members are provided as the transmitting members 12. However, the number of the transmitting members 12 according to the first exemplary embodiment is not particularly limited. The number of the transmitting members 12 may be an arbitrary number as long as the information terminal 100 does not become larger in size.

### Modified Example 2

According to the foregoing example, the driving units 11 are constituted by motors. However, the driving units according to the first exemplary embodiment are not limited to motors. The driving units 11 may be arbitrary types of actuators capable of pulling driving members, such as artificial muscle actuators performing stretching actions, and fibrous shape-memory alloy actuators.

According to the foregoing example, the position detecting units 30 are constituted by encoders for specifying the lengths of the transmitting members. However, the position detecting units 30 according to the first exemplary embodiment may be components other than encoders. For example, a camera provided on the rear of the information terminal may be provided as the position detecting units 30. In this case, the position of the attachment member 13 is optically detected. Alternatively, a magnetic sensor provided on the rear of the information terminal may be provided as the position detecting units 30. In this case, the position of the attachment member 13 is detectable when the attachment member 13 is made of material capable of emitting magnetism.

### Modified Example 4

According to the foregoing example, each of the positions of the through holes 16 corresponding to each pull start position of the transmitting members 12 is located at the apex of a right triangle formed with the vertical direction and the horizontal direction set to h and w, respectively, as illustrated in FIG. 5. However, the positions of the through holes 16 according to the first exemplary embodiment are not particularly limited. In addition, all the through holes are not required to be positioned within the same plane. The positions of the through holes 16 may be arbitrarily determined in appropriate manners within the range allowed by the thickness of the information terminal 100.

### Modified Example 5

According to the foregoing example, the tactile force presentation device 10 is incorporated within the information terminal 100. However, the tactile force presentation device 10 according to the first exemplary embodiment is not limited to this example. The tactile force presentation device 10 according to the first exemplary embodiment may be a device attachable to an existing information terminal as a retrofitted attachment device.

### Modified Example 6

According to the foregoing example, tactile force is presented in an operation space formed on the rear side of the information terminal 100. According to the first exemplary embodiment, however, the operation space may be disposed on the screen side of the information terminal 100. In this case, the direction of the initial force F₀ corresponds to the negative direction of the z axis (see FIG. 6).

### Modified Example 7

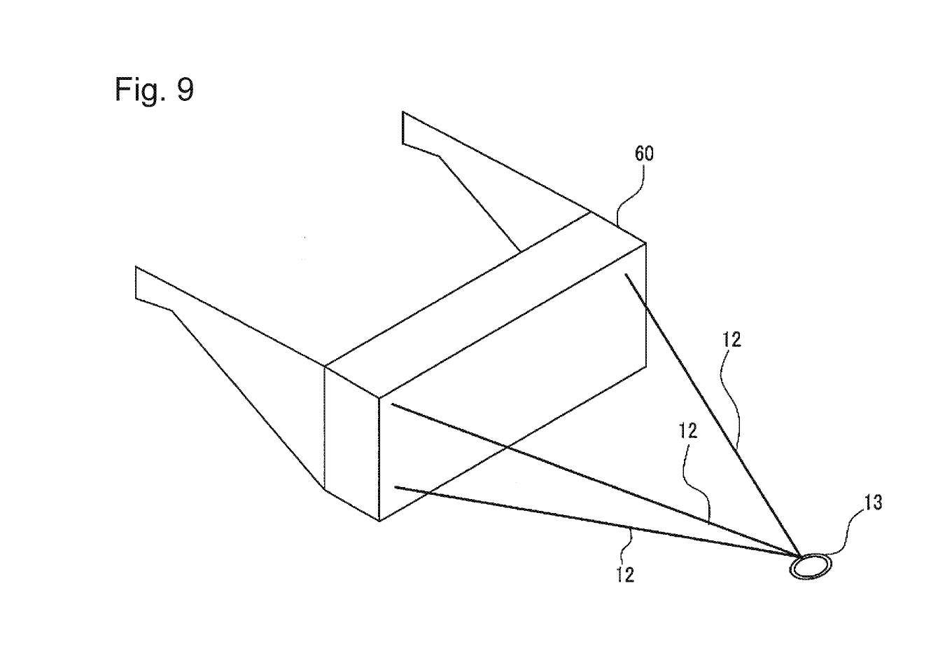

According to the foregoing example, the tactile force presentation device is applied to the tablet-type information terminal. However, the tactile force presentation device according to the first exemplary embodiment is not limited to this example. For example, the tactile force presentation device may be incorporated in a head-mounted display 60 attached to the face of the user as illustrated in FIG. 9.

FIG. 9 is a view illustrating an example of a head-mounted display including the tactile force presentation device according to the first exemplary embodiment of the present invention. In case of the example illustrated in FIG. 9, the user is allowed to feel the sense of touch by moving the finger in front of the head-mounted display 60 in the state in which the attachment member 13 is attached to the finger, while viewing content displayed on a display panel (not shown in FIG. 9) inside the head-mounted display 60.

### Modified Example 8

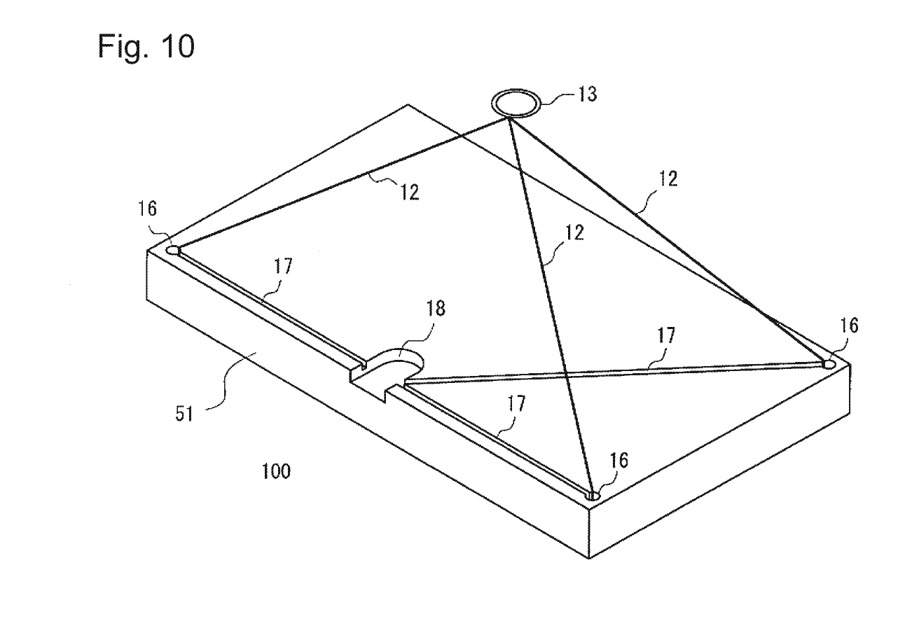

FIG. 10 is a perspective view illustrating another example of the information terminal according to the first exemplary embodiment of the present invention. In case of the example illustrated in FIG. 10, grooves 17 for accommodating the transmitting members 12, and a recess 18 for accommodating the attachment member 13 are formed in the bottom of the housing 51 constituting the information terminal 100. The information terminal 100 constructed as illustrated in FIG. 10 is more convenient for carrying by the user.

### Modified Example 9

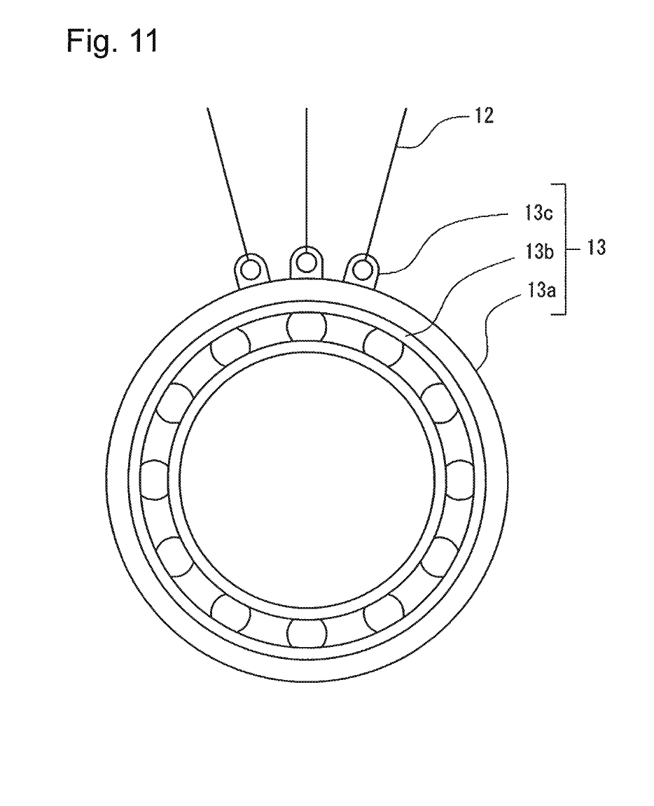

FIG. 11 is a view illustrating another example of the attachment member employed according to the first exemplary embodiment of the present invention. In case of the example illustrated in FIG. 11, the attachment member 13 is not a simple ring, but a component including a ring-shaped frame 13a, a ball bearing 13b embedded in the inner circumference of the frame 13a, and junction portions 13c connected to the transmitting members 12. In this case, a portion of the attachment member 13 in touch with the finger of the user rotates independently from the portions connected to the transmitting members 12, wherefore the following advantages are offered.

It is assumed herein that the user desires to touch the right side surface of the virtual object 103 by the finger to which the attachment member 13 is attached in the example illustrated in FIG. 1, for example. In this case, the user externally rotates the wrist to bring the pulp of the finger into contact with the virtual object 103. When the finger and the attachment member 13 are in tight contact with each other in this situation, the attachment member 13 rotates together with the finger by the external rotation of the wrist. This rotation of the attachment member 13 generates unexpected moment acting on the finger, wherefore presentation of accurate tactile force becomes difficult. In addition, entanglement of the transmitting members 12 around the finger may be caused.

In case of the attachment member 13 illustrated in FIG. 11, however, the portion of the attachment member 13 in contact with the finger of the user rotates independently from the portions connected to the transmitting members 12. This structure prevents actions produced by unexpected moment, entanglement of the transmitting members 12 around the finger of the user, and other problems. According to the example illustrated in FIG. 11, the ball bearing 13b is provided to allow independent rotation of the portion touching the finger of the user from the portions connected to the transmitting members 12. However, this modified example is not intended to be limited to this mode. The attachment member 13 may be constituted by arbitrary components as long as similar operation is achievable.

### Application Examples

Discussed herein according to the foregoing example as an example of content for which tactile force is presented has been content which links the finger of the user located in the actual space with the virtual object displayed on the screen. However, the content according to the first exemplary embodiment is not limited to this type. Another example of the content is hereinafter described.

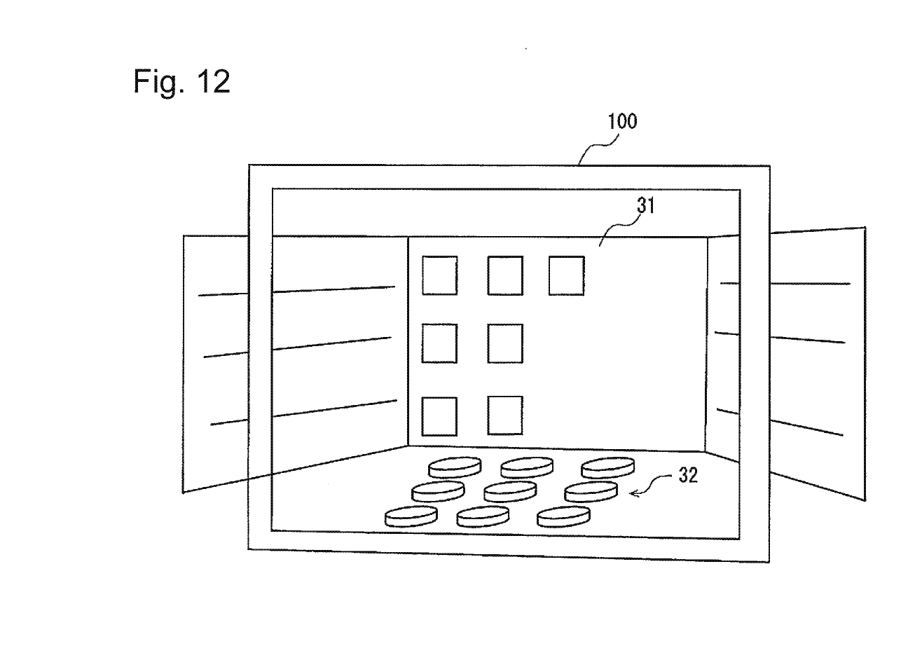

FIG. 12 is a view describing an example of content to which the first exemplary embodiment is applicable. According to the example illustrated in FIG. 12, a virtual touch panel 31 and a virtual keyboard 32 are provided in a virtual space as a virtual user interface. In this case, the user is allowed to feel as if the user is operating the virtual touch panel 31 and the virtual keyboard 32 disposed on the rear of the information terminal when moving the finger of the user on the rear of the information terminal.

### Application Example 2

The first exemplary embodiment is also applicable to navigation provided as content. More specifically, a direction of navigation is allowed to be presented as tactile force to the user when the tactile force presentation device according to the first exemplary embodiment is applied to a navigation device.

In this case, the user is capable of more securely recognizing the direction for advancement than in the case that the screen displays only the direction for advancement. In addition, virtual operation closer to actual operation is allowed to be given to the user when tactile force is presented with linkage to the movement of the screen at the time of scrolling of the screen.

### Application Example 3

The tactile force presentation device according to the first exemplary embodiment is capable of giving a feeling of operation closer to actual operation by presenting tactile force linked with scrolling movement of the screen to the user. For example, there is known a display method which bounds the display screen in the scroll direction to notify that further scrolling is not allowed due to the absence of further information during scrolling of the screen. When tactile force is presented in linkage with bounding of the display screen in the case of this display method, the user is allowed to rapidly receive accurate information closer to the actual operation.

### Application Example 4

The tactile force presentation device according to the first exemplary embodiment is capable of notifying that there is a link button or the like below the touching finger by way of presentation of tactile force when a website is displayed as content. In this case, the user is allowed to receive information difficult to obtain only through display information. In addition, the tactile force presentation device is capable of giving a warning by way of presentation of tactile force in such a manner that the link button is difficult to be pressed by the user when the link destination contains harmful sites.

### Application Example 5

The tactile force presentation device according to the first exemplary embodiment is applicable not only to linkage with a virtual object, but also to operation of a master-slave robot arm in response to input operation, for example. When controlling a remote-controlled robot arm with a view on a screen to operate an actual object, for example, the user may use the tactile force presentation device to receive tactile force as reaction to contact with an obstacle, or as a warning or the like prior to contact with an obstacle. In this case, the user is allowed to operate the robot arm more safely and more accurately.

### Application Example 6

The tactile force presentation device according to the first exemplary embodiment is applicable to state recognition of a tactile map or the like. In other words, the tactile force presentation device is applicable to map recognition by a visually impaired person. Moreover, when the tactile force presentation device is used by an ordinary user for presentation of tactile force in correspondence with walls and roads for the purpose of recognition of walls and routes in a 3D labyrinth or the like, shapes and conditions becomes more easily recognizable to the user.

### Application Example 7

The tactile force presentation device according to the first exemplary embodiment is applicable to presentation of information on stroke orders of Chinese characters in character leaning. For assisting children to understand character writing orders in Chinese character leaning, the tactile force presentation device may present tactile force as resistance force to input in directions other than the accurate input direction when the stroke order, Tobi, Hane and other ways of writing are inaccurate. The tactile force presentation device is useful for assisting character leaning.

### Application Example 8

The tactile force presentation device according to the first exemplary embodiment is applicable to a feedback device in simulation of musical instruments operation such as a piano, simulation of surgical operations, and simulation of clay modeling. In other words, the tactile force presentation device is capable of presenting tactile force as feedback for input from a device as pre-learning of the device or as an entertainment.

### Application Example 9

The tactile force presentation device according to the first exemplary embodiment is applicable to state recognition of products in purchasing products at a place other than an actual store, such as on a website and television. Unlike purchase of products at an actual store, an actual feeling of products is difficult to obtain in purchase of products on a website or television. However, the user utilizing the tactile force presentation device is capable of obtaining tactile information on the sense of touch on products, and therefore is capable of purchasing the products with deeper understanding.

### Application Example 10

The tactile force presentation device according to the first exemplary embodiment is applicable to an entertainment such as understanding of trompe l'oeil art. In this case, the tactile force presentation device presents information to the user as a feeling of wrongness by providing tactile force disagreeing with visual information. For example, trompe l'oeil art showing continuation of a spiral staircase produced by Maurits CornelisEscher is not allowed to be touched as an actual object, but is allowed to be touched by the user using the tactile force presentation device which presents the sense of touch on an object within a virtual space.

### Application Example 11

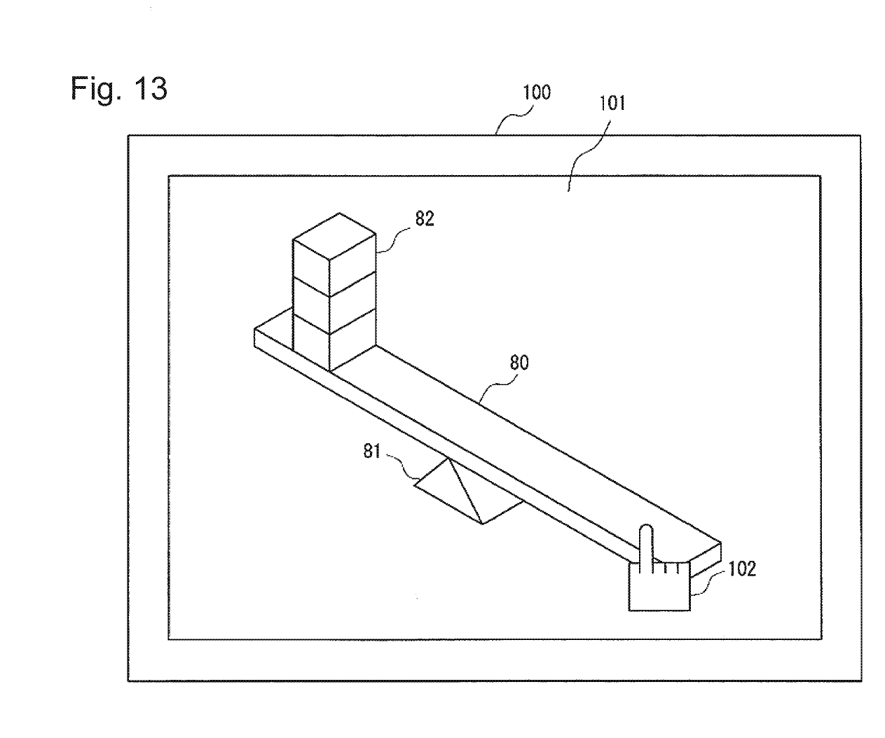

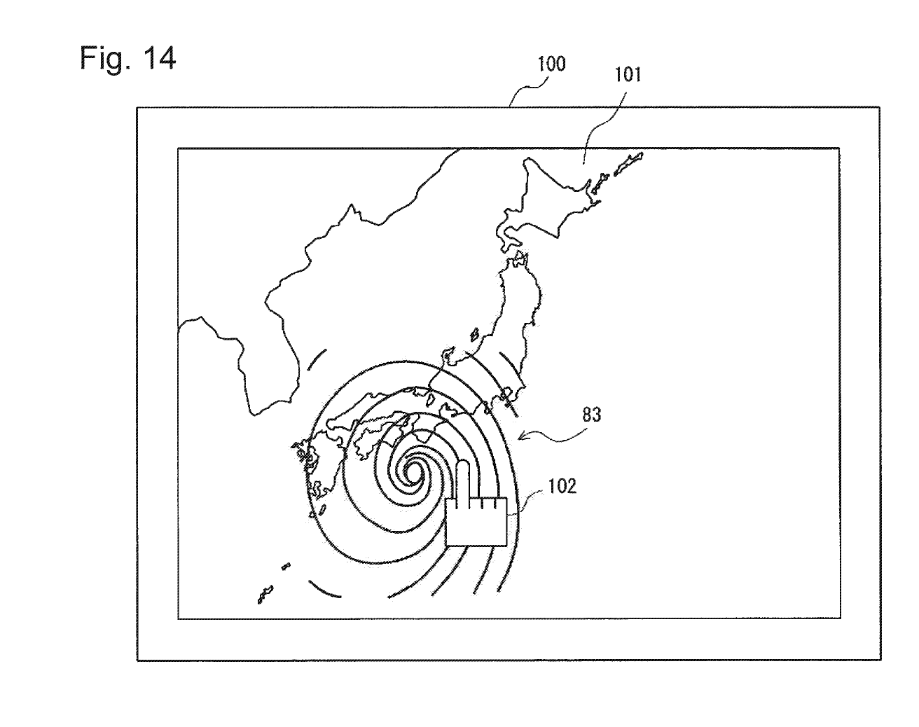

The tactile force presentation device according to the first exemplary embodiment is useful in the field of education. The use of the tactile force presentation device in the field of education is hereinafter described with reference to FIGS. 13 and 14.

FIG. 13 illustrates a case when content displayed on the screen of the information terminal is an experimental model for describing a principle of leverage. According to the example illustrated in FIG. 13, a seesaw 80 is disposed within a virtual space as a virtual object, and a weight 82 is placed at one end of the seesaw 80. In this case, the user supporting the other end of the seesaw 80 while changing the distance between the user supporting portion and a fulcrum 81 by operating the user object 102 is allowed to feel changes of force acting on the finger tip in accordance with changes of the distance from the fulcrum 81. Accordingly, in case of the example illustrated in FIG. 13, the user as a student is capable of understanding the principle of leverage while feeling tactile force.

FIG. 14 illustrates a case when content displayed on the screen of the information terminal is a model for describing a mechanism of a typhoon. In case of the example illustrated in FIG. 14, a typhoon model 83 is provided within a virtual space. Accordingly, tactile force expressing air currents of a typhoon is presented to the finger of the user when the user operates the user object 102 and brings the user object 102 into contact with the typhoon model 83. In this case, the strength of the force to be felt gradually increases as the user shifts the user object 102 closer to the center of the typhoon model 83. However, the strength becomes low at the center of the typhoon model 83. Accordingly, in case of the example illustrated in FIG. 14, the user as a student understands the mechanism of a typhoon while feeling tactile force. In this case, the user also easily understands that the directions of winds in the northern hemisphere become opposite to the directions of winds in the southern hemisphere.

[Program]

The program according to the first exemplary embodiment may be an arbitrary program as long as a computer can execute step S103 shown in FIG. 4 under the program. The tactile force presentation device 10 and the tactile force presenting method according to the first exemplary embodiment are realized by installing the program in a computer and executing the program. In this case, a CPU (Central Processing Unit) of the computer functions as the control unit 14 to perform processing.

A computer capable of realizing the tactile force presentation device 10 is not particularly limited, but may be a general-purpose personal computer as well as the microcomputer discussed herein. In addition, the computer capable of realizing the tactile force presentation device 10 may be a computer included in a cellular phone, a smartphone, or a tablet-type information terminal.

The program according to the first exemplary embodiment may be provided in a state recorded on a computer readable storage medium, or may be transmitted via the Internet. Specific examples of the storage medium include a general-purpose semiconductor storage device such as a CF (Compact Flash (registered trademark)) and an SD (Secure Digital), a magnetic storage medium such as a flexible disk, and an optical storage medium such as a CD-ROM (Compact Disk Read Only Memory).

### Advantages of First Exemplary Embodiment

According to the first exemplary embodiment, therefore, the user is allowed to feel tactile force in correspondence with contents when shifting the finger within a space on the rear side of the information terminal for operation of the content while viewing the content on the screen from the front of the information terminal. In this case, a sufficiently wide operational range is securable, wherefore presentation of tactile force is achievable in a wide range not only two-dimensionally, but also three-dimensionally including the depth direction according to the first exemplary embodiment.

In addition, tactile force is generated in consideration of perceptual characteristics of a human according to the first exemplary embodiment. Accordingly, the user does not have a feeling of wrongness when receiving the tactile force thus generated. Furthermore, the sufficient lengths of the transmitting members allow the user to shift the finger widely, wherefore the user does not have a feeling of wrongness when receiving tactile force also from this viewpoint.

Moreover, when string-shaped components are used as the transmitting members, complication of the tactile force presentation device decreases. Accordingly, reduction of the size and weight of the device is particularly achievable. Furthermore, the necessity of positioning of the motors or the like in a spatial manner is eliminated, wherefore the tactile force presentation device is applicable to a portable information terminal.

### Second Exemplary Embodiment

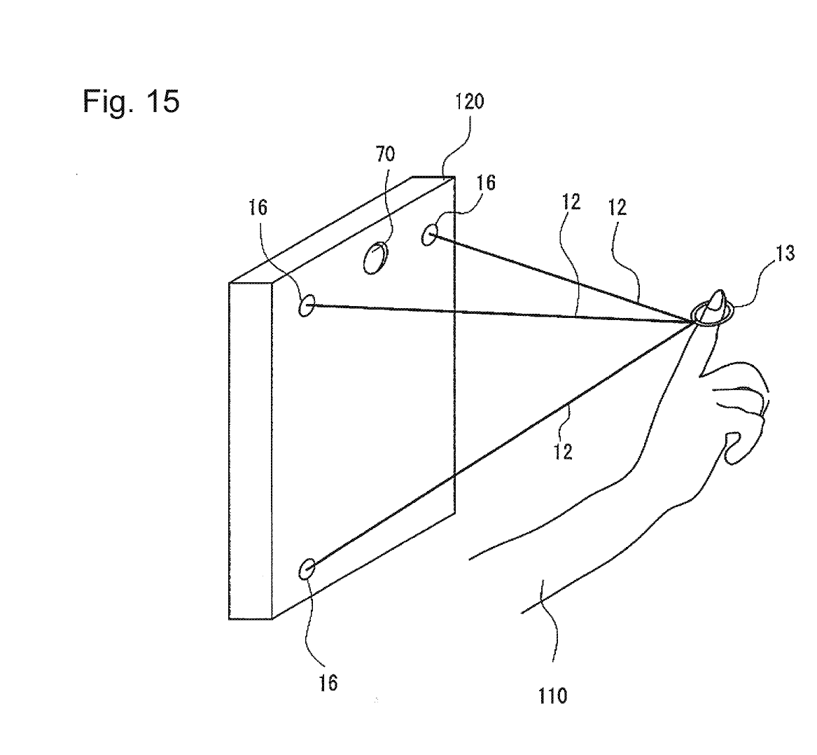

A tactile force presentation device, an information terminal, a tactile force presenting method, and a program according to a second exemplary embodiment of the present invention are hereinafter described with reference to FIGS. 15 through 19.

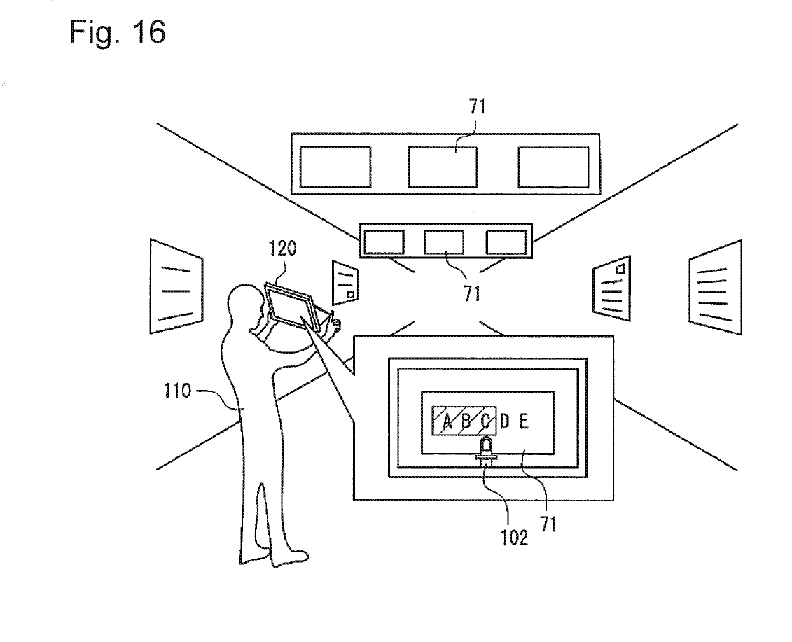

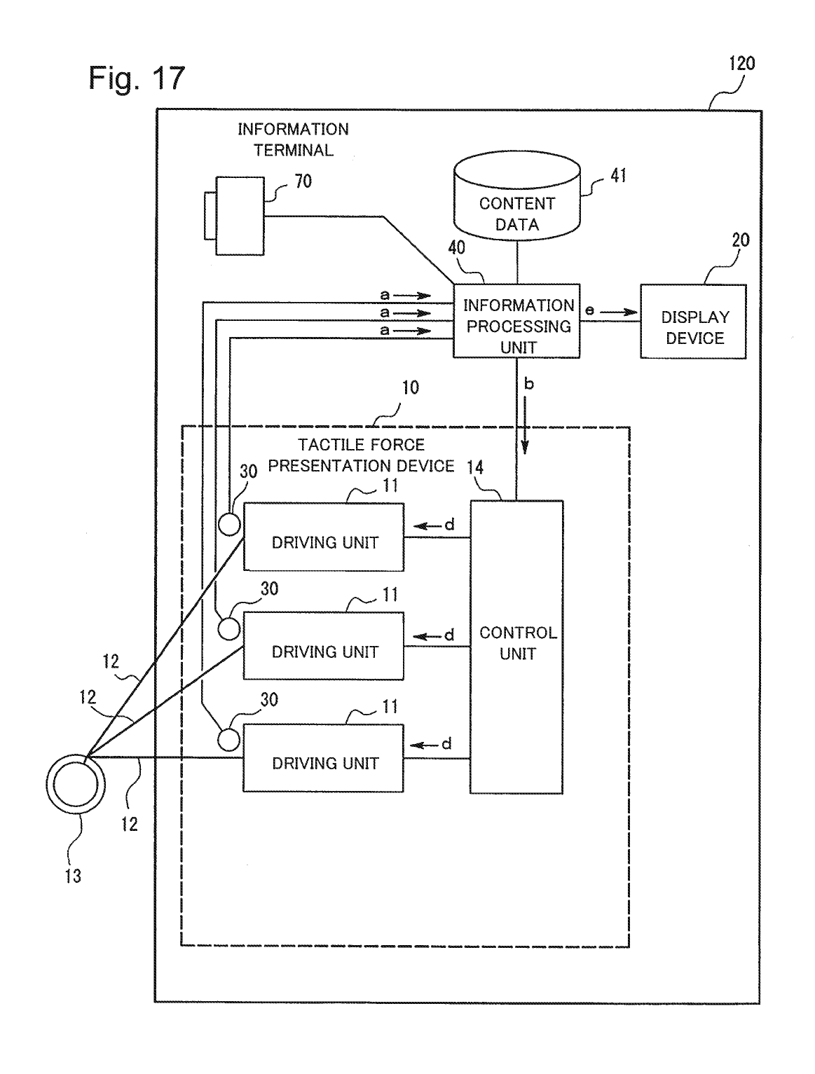

Initially, configurations of the tactile force presentation device and the information terminal according to the second exemplary embodiment are described with reference to FIGS. 15 through 17. FIG. 15 is a perspective view illustrating an external appearance of the information terminal according to the second exemplary embodiment of the present invention. FIG. 16 is a view illustrating a use example of the information terminal according to the second exemplary embodiment of the present invention. FIG. 17 is a block diagram illustrating the configuration of the information terminal according to the second exemplary embodiment of the present invention.

Initially, the external appearance of the information terminal according to the second exemplary embodiment is described with reference to FIG. 15. As illustrated in FIG. 15, an information terminal 120 according to the second exemplary embodiment is a tablet-type information terminal similarly to the information terminal 100 discussed in the first exemplary embodiment. However, the information terminal 120 in the second exemplary embodiment is different from the information terminal in the first exemplary embodiment in that a digital camera 70 capable of imaging a space on the rear side is provided on the information terminal 120.

Accordingly, the information terminal 120 is capable of linking an actual image imaged by the digital camera 70 with a shift of the finger corresponding to an action within an actual space. More specifically, as illustrated in FIG. 16, it is assumed herein that the user takes an image of an advertisement 71 located at a long distance from the user 110 by using the digital camera 70 on the rear side of the information terminal 120.

In this case, the advertisement 71 is disposed at a position difficult for the user to reach, wherefore the user 110 is not allowed to touch actually the advertisement 71. However, the user 110 is allowed to feel a touch on the advertisement 71 at a long distance based on tactile force presented to the finger from the tactile force presentation device. In addition, the user is allowed to more securely select text information when a touch on the text shown on the advertisement 71 is transmitted to the user as tactile force. Accordingly, information is more easily collectable from the real world.

As illustrated in FIG. 17, the information terminal 120 includes the digital camera 70. An image imaged by the digital camera 70 is transmitted to the information processing unit 40. Unlike the first exemplary embodiment, the information processing unit 40 executes the content linkage process for the image imaged by the digital camera 70 as a processing target. The information terminal 120 is constructed similarly to the information terminal 100 illustrated in FIG. 3 except for the point that the digital camera 70 is equipped.

Accordingly, objects are receivable from the real world, and the user is allowed to touch these objects in the second exemplary embodiment. In addition, targets in the second exemplary embodiment are not limited to objects located at long distances as illustrated in FIG. 17, but may be extremely dangerous objects not allowed to be touched, such as large carnivorous animals, for example.

Similarly to the first exemplary embodiment, the information terminal 120 in the second exemplary embodiment executes the processes in steps S101 through S104 illustrated in FIG. 4. In addition, the tactile force presenting method in the second exemplary embodiment is also realized by operation of the tactile force presentation device in the second exemplary embodiment.

The program according to the second exemplary embodiment may be an arbitrary program as long as a computer can execute step S103 shown in FIG. 4 under the program, similarly to the first exemplary embodiment. The tactile force presentation device and the tactile force presenting method according to the second exemplary embodiment are realized by installing the program in a computer and executing the program. In this case, a CPU (Central Processing Unit) of the computer functions as a control unit to perform processing.

### Modified Examples of Second Exemplary Embodiment

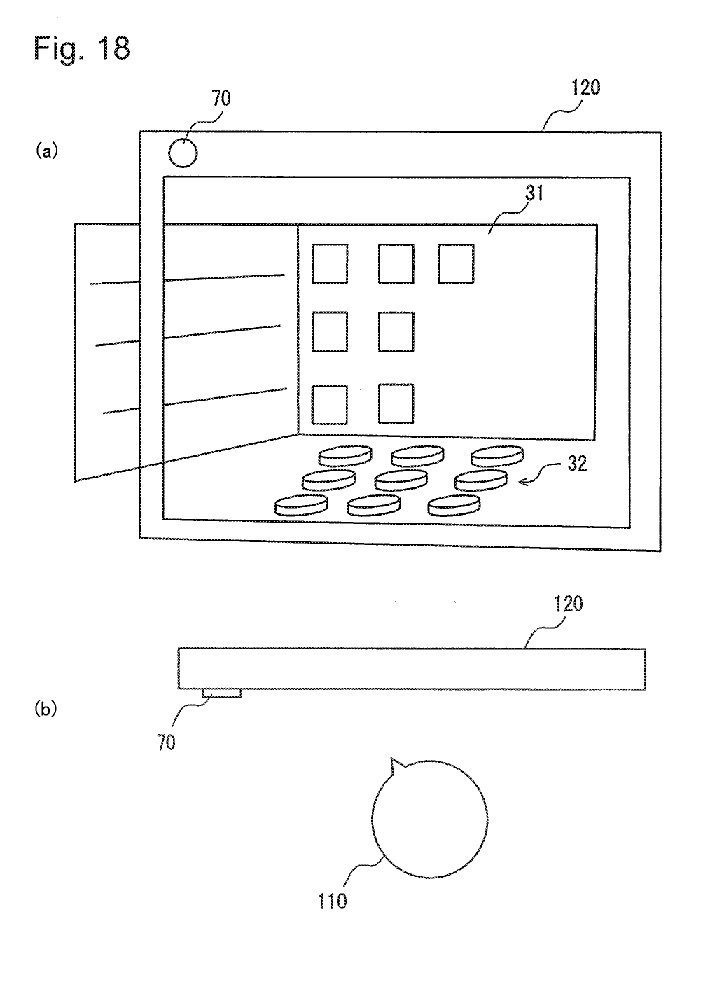

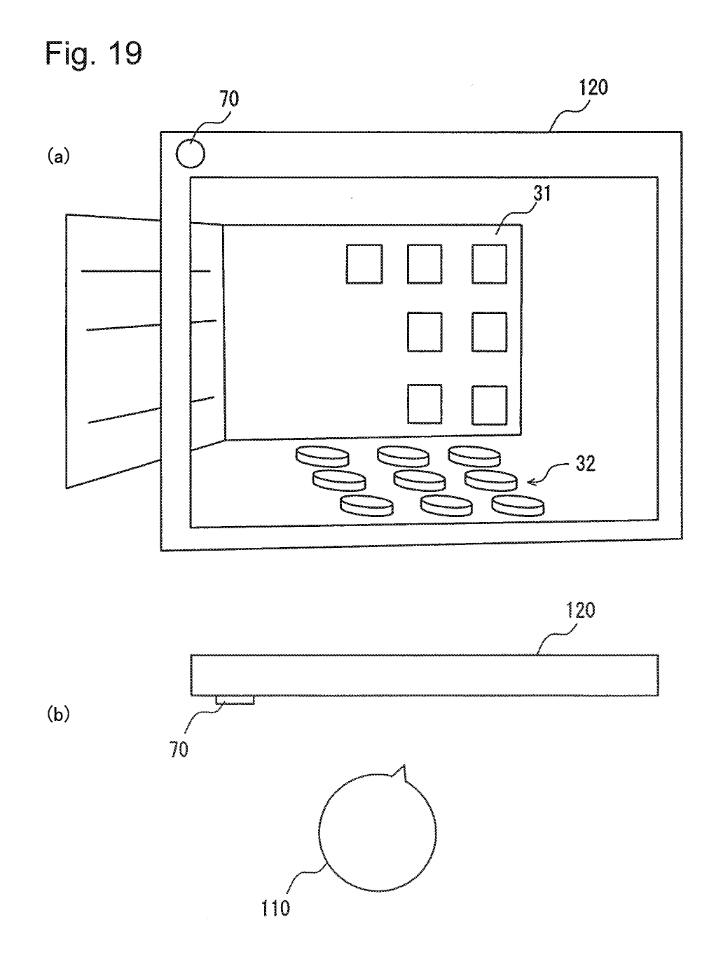

According to the second exemplary embodiment, the digital camera 70 may be disposed in such a position as to image a space on the screen side (front side) of the information terminal. In this case, a state of a virtual space displayed on the display device is allowed to be linked with the movement of the user. This example is now detailed with reference to FIGS. 18 and 19.

FIG. 18(a) and FIG. 19(a) are views each illustrating an example of a screen displayed on an information terminal according to a modified example of the second exemplary embodiment of the present invention, while FIGS. 18(b) and 19(b) are views each illustrating a relationship between the screen and the direction of the face of the user.

Similarly to the example illustrated in FIG. 12, in this modified example, the virtual touch panel 31 and the virtual keyboard 32 are disposed within a virtual space as a virtual user interface. In this case, the user is allowed to feel as if the user is operating the virtual touch panel 31 and the virtual keyboard 32 disposed on the rear of the information terminal by moving the finger on the rear of the information terminal.

However, as illustrated in FIGS. 18(a) and 18(b) and FIGS. 19(a) and 19(b), the information terminal 120 in this modified example detects the direction of the face of the user using the digital camera 70 disposed on the screen side. Accordingly, the information terminal 120 is capable of changing the visual performance of content displayed on the screen in accordance with a change of the viewing direction of the screen by the user. When this modified example is employed, display becomes variable in accordance with viewpoints of the user. This advantage contributes to more effective utilization of the virtual space.

A part or all of the foregoing exemplary embodiments may be expressed as in (Supplementary Note 1) through (Supplementary Note 15) described hereinbelow, but are not limited to these descriptions.

(Supplementary Note 1)

A tactile force presentation device that presents tactile force to a user in accordance with contents displayed on a screen, the device is characterized by including:

a transmitting member that extends toward a portion at which the user receives presentation of the tactile force from the device, and transmits a force to the user as the force in a pulling direction;

a driving unit that generates the force in the pulling direction, and gives the force to the transmitting member; and

a control unit that allows the driving unit to generate the force in strength set beforehand in the pulling direction as an initial force, and increases or decreases the initial force such that the tactile force for presentation is transmitted to the user via the transmitting member in the presentation of the tactile force.

(Supplementary Note 2)

The tactile force presentation device according to Supplementary Note 1, including a plurality of the transmitting members, and a plurality of the driving units in correspondence with the plurality of transmitting members, wherein

each of the plurality of transmitting members is a string-shaped member configured such that the respective transmitting members extend from different positions of the device toward the portion at which the user receives presentation of the tactile force,

a tip of each of the plurality of transmitting members is fixed to an attachment member attached to the portion at which the user receives presentation of the tactile force,

the plurality of driving units give force in the pulling direction to the corresponding transmitting members by winding the corresponding transmitting members, and

the tactile force is presented as a resultant force of the forces given in the pulling direction from the plurality of driving units to the corresponding transmitting members.

(Supplementary Note 3)

The tactile force presentation device according to Supplementary Note 1 or 2, wherein the control unit resets the tactile force for presentation by increasing or decreasing the initial force such that the reset tactile force is presented when a state in which the tactile force for presentation is not presented by a resultant force of the forces in the pulling direction occurs.

(Supplementary Note 4)

The tactile force presentation device according to Supplementary Note 2, wherein three or a larger number of the string-shaped members are provided.

(Supplementary Note 5)

The tactile force presentation device according to any one of Supplementary Notes 1 through 4, wherein the tactile force presentation device is incorporated in a head-mounted display.

(Supplementary Note 6)

An information terminal capable of presenting tactile force to a user in accordance with contents displayed on a screen, the terminal is characterized by including:

a display device that displays the content on the screen;

a position detecting unit that detects a position of a portion at which the user receives presentation of the tactile force;

an information processing unit that changes contents of the content in accordance with a detected position, and calculates tactile force for presentation based on the changed contents of the content; and

a tactile force presentation device, wherein

the tactile force presentation device includes
a transmitting member that extends from the information terminal toward the portion at which the user receives presentation of the tactile force, and transmits a force to the user as the force in a pulling direction,
a driving unit that generates the force in the pulling direction, and gives the force to the transmitting member, and
a control unit that allows the driving unit to generate the force in strength set beforehand in the pulling direction as an initial force, and increases or decreases the initial force such that the calculated tactile force is transmitted to the user via the transmitting member in the presentation of the tactile force calculated by the information processing unit.

(Supplementary Note 7)

The information terminal according to Supplementary Note 6, including a plurality of the transmitting members, and a plurality of the driving units in correspondence with the plurality of transmitting members, wherein

each of the plurality of transmitting members is a string-shaped member configured such that the respective transmitting members extend from different positions of the information terminal toward the portion at which the user receives presentation of the tactile force,

a tip of each of the plurality of transmitting members is fixed to an attachment member attached to the portion at which the user receives presentation of the tactile force,

the plurality of driving units give force in the pulling direction to the corresponding transmitting members by winding the corresponding transmitting members, and

the tactile force is presented as a resultant force of the forces given in the pulling direction from the plurality of driving units to the corresponding transmitting members.

(Supplementary Note 8)

The information terminal according to Supplementary Note 6 or 7, wherein the control unit resets the tactile force for presentation by increasing or decreasing the initial force such that the reset tactile force is presented when a state in which the tactile force for presentation is not presented by a resultant force of the forces in the pulling direction occurs.

(Supplementary Note 9)

The information terminal according to Supplementary Note 7, wherein three or a larger number of the string-shaped members are provided.

(Supplementary Note 10)

A tactile force presenting method that presents tactile force to a user in accordance with contents displayed on a screen, the method using a device that includes a transmitting member that extends toward a portion at which the user receives presentation of the tactile force, and transmits a force to the user as the force in a pulling direction, and a driving unit that generates the force in the pulling direction, and gives the force to the transmitting member, the method is characterized by including:

(a) a step for allowing the driving unit to generate the force in strength set beforehand in the pulling direction as an initial force; and

(b) a step for increasing or decreasing the initial force such that the tactile force for presentation is transmitted to the user via the transmitting member in the presentation of the tactile force.

(Supplementary Note 11)

The tactile force presenting method according to Supplementary Note 10, wherein

the device includes a plurality of the transmitting members, and a plurality of the driving units in correspondence with the plurality of transmitting members,

each of the plurality of transmitting members is a string-shaped member configured such that the respective transmitting members extend from different positions of the device toward the portion at which the user receives presentation of the tactile force,

a tip of each of the plurality of transmitting members is fixed to an attachment member attached to the portion at which the user receives presentation of the tactile force,

the plurality of driving units give force in the pulling direction to the corresponding transmitting members by winding the corresponding transmitting members, and

the tactile force is presented as a resultant force of the forces given in the pulling direction from the plurality of driving units to the corresponding transmitting members.

(Supplementary Note 12)

The tactile force presenting method according to Supplementary Note 10 or Supplementary Note 11, further including (c) a step for resetting the tactile force for presentation by increasing or decreasing the initial force such that the reset tactile force is presented when a state in which the tactile force for presentation is not presented by a resultant force of the forces in the pulling direction occurs.

(Supplementary Note 13)

The tactile force presenting method according to Supplementary Note 11, wherein three or a larger number of the string-shaped members are provided.

(Supplementary Note 14)

A computer readable storage medium storing a program that causes a device which includes a transmitting member that extends toward a portion of the a for receiving presentation of the tactile force, and transmits the force to the user as the force in a pulling direction, a driving unit that generates the force in the pulling direction, and gives the force to the transmitting member, and a computer, to execute

(a) a step for allowing the driving unit to generate the force in strength set beforehand in the pulling direction as an initial force; and

(b) a step for increasing or decreasing the initial force such that the tactile force for presentation is transmitted to the user via the transmitting member in the presentation of the tactile force.

so that the device presents the tactile force to the user in accordance with contents displayed on a screen.

(Supplementary Note 15)

The computer readable storage medium according to Supplementary Note 14, wherein

the device includes a plurality of the transmitting members, and a plurality of the driving units in correspondence with the plurality of transmitting members,

each of the plurality of transmitting members is a string-shaped member configured such that the respective transmitting members extend from different positions of the device toward the portion at which the user receives presentation of the tactile force,

a tip of each of the plurality of transmitting members is fixed to an attachment member attached to the portion at which the user receives presentation of the tactile force,

the plurality of driving units give force in the pulling direction to the corresponding transmitting members by winding the corresponding transmitting members, and

the tactile force is presented as a resultant force of the forces given in the pulling direction from the plurality of driving units to the corresponding transmitting members.

(Supplementary Note 16)

The computer readable storage medium according to Supplementary Note 14 or Supplementary Note 15, wherein the program further includes a command for causing the computer to further execute (c) a step for resetting the tactile force for presentation by increasing or decreasing the initial force such that the reset tactile force is presented when a state in which the tactile force for presentation is not presented by a resultant force of the forces in the pulling direction occurs.

(Supplementary Note 17)

The computer readable storage medium according to Supplementary Note 15, wherein three or a larger number of the string-shaped members are provided.

While the invention of the present application has been described with reference to the foregoing exemplary embodiments, the invention of the present application is not limited to the above-described exemplary embodiments. Various modifications and changes understandable to those skilled in the art may be made to the configurations and details of the invention of the present application without departing from the scope of the invention of the present application.

This application claims priority to Japanese Patent Application No. 2013-14206, filed Jan. 29, 2013, the entirety of which is hereby incorporated by reference.

### INDUSTRIAL APPLICABILITY

According to the present invention, presentation of three-dimensional tactile force is achievable in a wide range at the time of presentation of tactile force, together with reduction of a device size. The present invention is a useful technology applicable to various fields requiring presentation of tactile force, such as computer interfaces, various types of simulation, and games.

### REFERENCE SIGNS LIST

10 tactile force presentation device
11 driving unit
12 transmitting member
13 attachment member
13a frame
13b ball bearing
13c junction portion
14 control unit
15 pulley
16 through hole
17 groove
18 recess
20 display device
30 position detecting unit
31 virtual touch panel
32 virtual keyboard
40 information processing unit
50 cover
51 housing
60 head-mounted display
70 camera
71 advertisement
80 seesaw
81 fulcrum
82 weight
83 typhoon model
100 information terminal (first exemplary embodiment)
101 screen
102 user object
103 virtual object
110 user
120 information terminal (second exemplary embodiment)
a position detection data
b presentation data
d control data
e display data

What is claimed is:

1. A tactile force presentation device that presents tactile force to a user in accordance with contents displayed on a screen, the device comprising:
a transmitting member that extends toward a portion at which the user receives presentation of the tactile force from the device, and transmits a force to the user as the force in a pulling direction;
a driving unit that generates the force in the pulling direction, and gives the force to the transmitting member; and
a control unit that allows the driving unit to generate the force in strength set beforehand in the pulling direction as an initial force, and increases or decreases the initial force such that the tactile force for presentation is transmitted to the user via the transmitting member in the presentation of the tactile force.

2. The tactile force presentation device according to claim 1, comprising a plurality of the transmitting members, and a plurality of the driving units in correspondence with the plurality of transmitting members, wherein
each of the plurality of transmitting members is a string-shaped member configured such that the respective transmitting members extend from different positions of the device toward the portion at which the user receives presentation of the tactile force,
a tip of each of the plurality of transmitting members is fixed to an attachment member attached to the portion at which the user receives presentation of the tactile force,
the plurality of driving units give force in the pulling direction to the corresponding transmitting members by winding the corresponding transmitting members, and
the tactile force is presented as a resultant force of the forces given in the pulling direction from the plurality of driving units to the corresponding transmitting members.

3. The tactile force presentation device according to claim 1, wherein the control unit resets the tactile force for presentation by increasing or decreasing the initial force such that the reset tactile force is presented when a state in which the tactile force for presentation is not presented by a resultant force of the forces in the pulling direction occurs.

4. The tactile force presentation device according to claim 2, wherein three or a larger number of the string-shaped members are provided.

5. The tactile force presentation device according to claim 1, wherein the tactile force presentation device is incorporated in a head-mounted display.

6. An information terminal capable of presenting tactile force to a user in accordance with contents displayed on a screen, the terminal comprising:
a display device that displays the content on the screen;
a position detecting unit that detects a position of a portion at which the user receives presentation of the tactile force;
an information processing unit that changes contents of the content in accordance with a detected position, and calculates tactile force for presentation based on the changed contents of the content; and
a tactile force presentation device, wherein
the tactile force presentation device includes
a transmitting member that extends from the information terminal toward the portion at which the user receives presentation of the tactile force, and transmits a force to the user as the force in a pulling direction,
a driving unit that generates the force in the pulling direction, and gives the force to the transmitting member, and
a control unit that allows the driving unit to generate the force in strength set beforehand in the pulling direction as an initial force, and increases or decreases the initial force such that the calculated tactile force is transmitted to the user via the transmitting member in the presentation of the tactile force calculated by the information processing unit.

7. The information terminal according to claim 6, comprising a plurality of the transmitting members, and a plurality of the driving units in correspondence with the plurality of transmitting members, wherein
each of the plurality of transmitting members is a string-shaped member configured such that the respective transmitting members extend from different positions of the information terminal toward the portion at which the user receives presentation of the tactile force,
a tip of each of the plurality of transmitting members is fixed to an attachment member attached to the portion at which the user receives presentation of the tactile force,
the plurality of driving units give force in the pulling direction to the corresponding transmitting members by winding the corresponding transmitting members, and
the tactile force is presented as a resultant force of the forces given in the pulling direction from the plurality of driving units to the corresponding transmitting members.

8. The information terminal according to claim 6, wherein the control unit resets the tactile force for presentation by increasing or decreasing the initial force such that the reset tactile force is presented when a state in which the tactile force for presentation is not presented by a resultant force of the forces in the pulling direction occurs.

9. A tactile force presenting method that presents tactile force to a user in accordance with contents displayed on a screen, the method using a device that includes a transmitting member that extends toward a portion at which the user receives presentation of the tactile force, and transmits a force to the user as the force in a pulling direction, and a driving unit that generates the force in the pulling direction, and gives the force to the transmitting member, the method comprising:
(a) a step for allowing the driving unit to generate the force in strength set beforehand in the pulling direction as an initial force; and
(b) a step for increasing or decreasing the initial force such that the tactile force for presentation is transmitted to the user via the transmitting member in the presentation of the tactile force.

10. A non-transitory computer readable storage medium storing a program that causes a device which includes a transmitting member that extends toward a portion of a user for receiving presentation of the tactile force, and transmits the force to the user as the force in a pulling direction, a driving unit that generates the force in the pulling direction, and gives the force to the transmitting member, and a computer, to execute:
(a) a step for allowing the driving unit to generate the force in strength set beforehand in the pulling direction as an initial force; and
(b) a step for increasing or decreasing the initial force such that the tactile force for presentation is transmitted to the user via the transmitting member in the presentation of the tactile force
so that the device presents the tactile force to the user in accordance with contents displayed on a screen.
